(19) United States
(12) Patent Application Publication
(10) Pub. No.: US 2025/0193497 A1
(43) Pub. Date: Jun. 12, 2025

(54) ELECTRONIC APPARATUS AND OPERATING METHOD THEREOF

(71) Applicant: SAMSUNG ELECTRONICS CO., LTD., Suwon-si (KR)

(72) Inventors: Sungchang JANG, Suwon-si (KR); Kyoungjae PARK, Suwon-si (KR); Yongwoo SHIN, Suwon-si (KR); Sangyoung LEE, Suwon-si (KR); Inwoo HWANG, Suwon-si (KR)

(73) Assignee: SAMSUNG ELECTRONICS CO., LTD., Suwon-si (KR)

(21) Appl. No.: 19/000,032

(22) Filed: Dec. 23, 2024

Related U.S. Application Data
(63) Continuation of application No. PCT/KR2024/096723, filed on Dec. 11, 2024.

(30) Foreign Application Priority Data
Dec. 12, 2023 (KR) 10-2023-0180091

(51) Int. Cl. H04N 21/81; H04N 21/485

(52) U.S. Cl. CPC H04N 21/8133; H04N 21/4852; H04N 21/4854

(57) ABSTRACT

An electronic apparatus identifies a representative genre of a content, based on information about the content; performs at least one of video image quality control or audio sound quality control on the content by setting at least one of video image quality or audio sound quality for playing the content to a preset value, based on the identified representative genre; identifies a partial genre of the content, based on analysis of a scene including at least one of a video frame or an audio frequency corresponding to at least a part of the content played; and performs at least one of the video image quality control or the audio sound quality control on the content by assigning a weight to the preset value, based on the identified partial genre.

### CROSS-REFERENCE TO RELATED APPLICATIONS

This application is a continuation application of International Application No. PCT/KR2024/096723, filed on Dec. 11, 2024, which claims priority to Korean Patent Application No. 10-2023-0180091, filed on Dec. 12, 2023, the disclosures of which are incorporated by reference herein in their entireties.

### BACKGROUND

### 1. Field

The disclosure relates to an electronic apparatus that plays content, and more particularly, to an electronic apparatus that plays content while providing an audio visual effect suitable for characteristics of the content, and an operating method of the electronic apparatus.

### 2. Description of Related Art

With technological developments of display apparatuses, display apparatuses capable of implementing various functions are being developed. A representative example of a display apparatus is a television (TV). Related art TVs perform the simple function of receiving broadcast signals and playing the corresponding broadcast content (for example, news, dramas, pop programs, etc.).

Recently, with the technological development of display apparatuses, various applications or programs are stored in and installed on TVs to perform various functions, and various functions and services in addition to broadcast content playback functions are provided through the installed applications. For example, game applications are stored and installed on TVs, and game content is played through the game applications.

As communication technology or communication connection functions of display apparatuses are developed, the display apparatuses provide various functions or services through wired or wireless communication with external apparatuses. For example, a display apparatus is connected to an external apparatus such as a game console device or game server, which provides game content through wired or wireless communication, and the display apparatus receives game content from the external apparatus or game server through wired or wireless communication.

In order to maximize the player's game experience and improve the player's immersion in the game while playing game content on a display apparatus, the display apparatus provides image quality and/or sound quality suitable for the game content.

### SUMMARY

According to an aspect of the disclosure, there is provided an electronic apparatus including: memory storing at least one instruction; and at least one processor configured to execute the at least one instruction, wherein the at least one instruction, when executed by the at least one processor, causes the electronic apparatus to: identify a representative genre of a content, based on information about the content; perform at least one of video image quality control or audio sound quality control on the content by setting at least one of video image quality or audio sound quality for playing the content to a preset value, based on the identified representative genre; identify a partial genre of the content, based on analysis of a scene including at least one of a video frame or an audio frequency corresponding to at least a part of the content played; and perform at least one of the video image quality control or the audio sound quality control on the content by assigning a weight to the preset value, based on the identified partial genre.

The at least one instruction, when executed by the at least one processor, causes the electronic apparatus to: recognize that play of the content has begun; obtain title information of the played content by analyzing an image of the content; and identify the representative genre of the content, based on the title information of the content.

The content may include game content, and the at least one instruction, when executed by the at least one processor, causes the electronic apparatus to: recognize that play of the content has begun, based on at least one signal among Variable Refresh Rate (VRR), Auto Low Latency Mode (ALLM), or ContentsType, received from an external apparatus connected to the electronic apparatus to provide the content.

The at least one instruction, when executed by the at least one processor, causes the electronic apparatus to: identify, as the representative genre of the content, a genre selected from among a plurality of preset genres, based on the information about the content.

The at least one instruction, when executed by the at least one processor, causes the electronic apparatus to: identify, as the partial genre of the content, a genre selected from a plurality of preset genres, based on the analysis of the scene.

The at least one instruction, when executed by the at least one processor, causes the electronic apparatus to: obtain at least one of a setting value of at least one parameter for controlling the video image quality, or a setting value of at least one parameter for controlling the audio sound quality, corresponding to the representative genre; and control at least one of the video image quality or the audio sound quality, by setting the at least one parameter for controlling the video image quality by using the setting value of the at least one parameter for controlling the video image quality or by setting the at least one parameter for controlling the audio sound quality by using the setting value of the at least one parameter for controlling the audio sound quality.

The at least one instruction, when executed by the at least one processor, causes the electronic apparatus toto: perform at least one of the video image quality control or the audio sound quality control on the content, by adjusting at least one of a setting value of at least one parameter for setting the video image quality or a setting value of at least one parameter for setting the audio sound quality, corresponding to the representative genre, by using the weight corresponding to the identified partial genre.

The at least one instruction, when executed by the at least one processor, causes the electronic apparatus to: identify whether the identified partial genre is identical to the representative genre; perform, based on the identified partial genre being identical to the representative genre, at least one of the video image quality control or the audio sound quality control by using at least one of a setting value of at least one parameter for controlling the video image quality or a setting value of at least one parameter for controlling the audio sound quality, corresponding to the representative genre; and adjust, based on the identified partial genre being different from the representative genre, at least one of the setting value of the at least one parameter for controlling the video image quality or the setting value of the at least one parameter for controlling the audio sound quality, corresponding to the representative genre, by using the weight corresponding to the identified partial genre.

The at least one instruction, when executed by the at least one processor, causes the electronic apparatus to: obtain a table storing the weight that is added to a setting value of at least one parameter for controlling the video image quality, corresponding to the representative genre, in correspondence with each of a plurality of preset genres, wherein the weight varies in a range of preset values.

According to an aspect of the disclosure, there is provided an operating method of an electronic apparatus including: identifying a representative genre of a content, based on information about the content; performing at least one of video image quality control or audio sound quality control on the content by setting at least one of video image quality or audio sound quality for playing the content to a preset value, based on the identified representative genre; identifying a partial genre of the content, based on analysis of a scene including at least one of video frame or an audio frequency corresponding to at least a part of the content played; and performing at least one of the video image quality control or the audio sound quality control on the content by assigning a weight to the preset value, based on the identified partial genre.

The operating method may further include recognizing that play of the content has begun; obtaining title information of the played content by analyzing an image of the content; and identifying the representative genre of the content, based on the title information of the content.

The content includes game content, and wherein the operating method may further include: recognizing that play of the content has begun, based on at least one signal among Variable Refresh Rate (VRR), Auto Low Latency Mode (ALLM), or ContentsType, received from an external apparatus connected to the electronic apparatus to provide the content.

The operating method may further include identifying a genre selected from among a plurality of preset genres as the representative genre of the content, based on the information about the content.

The operating method may further include identifying, as the partial genre of the content, a genre selected from a plurality of preset genres, based on the analysis of the scene.

The operating method may further include obtaining at least one of a setting value of at least one parameter for controlling the video image quality or a setting value of at least one parameter for controlling the audio sound quality, corresponding to the representative genre; and controlling at least one of the video image quality or the audio sound quality, by setting the at least one parameter for controlling the video image quality by using the setting value of the at least one parameter for controlling the video image quality or by setting the at least one parameter for controlling the audio sound quality by using the setting value of the at least one parameter for controlling the audio sound quality.

The operating method may further include performing at least one of the video image quality control or the audio sound quality control on the content, by adjusting at least one of a setting value of at least one parameter for setting the video image quality or a setting value of at least one parameter for setting the audio sound quality, corresponding to the representative genre, by using the weight corresponding to the identified partial genre.

The operating method may further include identifying whether the identified partial genre is identical to the representative genre; performing, based on the identified partial genre being identical to the representative genre, at least one of the video image quality control or the audio sound quality control by using at least one of a setting value of at least one parameter for controlling the video image quality or a setting value of at least one parameter for controlling the audio sound quality, corresponding to the representative genre; and adjusting, based on the identified partial genre being different from the representative genre, at least one of the setting value of the at least one parameter for controlling the video image quality or the setting value of the at least one parameter for controlling the audio sound quality, corresponding to the representative genre, by using the weight corresponding to the identified partial genre.

The operating method may further include obtaining a table storing the weight that is added to a setting value of at least one parameter for controlling the video image quality, corresponding to the representative genre, in correspondence with each of a plurality of preset genres, wherein the weight varies in a range of preset values.

According to an aspect of the disclosure, there is provided a non-transitory computer-readable recording medium storing at least one instruction to cause, when the at least one instruction is executed by at least one processor of an electronic apparatus, the electronic apparatus to: identify a representative genre of a content, based on information about the content; perform at least one of video image quality control or audio sound quality control on the content by setting at least one of video image quality or audio sound quality for playing the content to a preset value, based on the identified representative genre; identify a partial genre of the content, based on analysis of a scene including at least one of video frame or an audio frequency corresponding to at least a part of the content played; and perform at least one of the video image quality control or the audio sound quality control on the content by assigning a weight to the preset value, based on the identified partial genre.

The at least one instruction may be executed by the at least one processor to cause the electronic apparatus to: recognize that play of the content has begun; obtain title information of the played content by analyzing an image of the content; and identify the representative genre of the content, based on the title information of the content.

Effects that may be achieved by embodiments of the disclosure are not limited to the above-mentioned effects, and other effects not mentioned will be clearly understood by one of ordinary skill in the technical field to which the disclosure belongs from the following descriptions.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows an example of a system for playing content, according to an embodiment of the disclosure;

FIG. 2 shows an example of a schematic block diagram of apparatuses included in a system according to an embodiment of the disclosure;

FIG. 3 shows an example of a block diagram of an electronic apparatus according to an embodiment of the disclosure;

FIG. 4 shows a functional block diagram of an image quality/sound quality processor according to an embodiment of the disclosure;

FIG. 5 shows an example of a module for storing image quality and sound quality control parameter value information for each genre, according to an embodiment of the disclosure;

FIG. 6 shows an example of a flowchart illustrating an operating method of an electronic apparatus, according to an embodiment of the disclosure;

FIG. 7 shows an example of an operating method of an electronic apparatus, according to an embodiment of the disclosure;

FIG. 8 is a reference view for describing a method of recognizing content by analyzing a content image screen in an electronic apparatus, according to an embodiment of the disclosure;

FIG. 9 is a reference view for describing an example of applying weights to image quality control parameters and sound quality control parameters, according to an embodiment of the disclosure;

FIG. 10 is a reference view for describing an example of analyzing and processing image quality or sound quality for each genre of game content, according to an embodiment of the disclosure;

FIG. 11 shows weight tables for representative genres of Roll Playing Game (RPG), Real Time Strategy (RTS), First Person Shooter (FPS), and SPORTS, according to an embodiment of the disclosure; and

FIG. 12 is a reference view for describing an example of image quality control based on representative genres and partial genres while game content is played, according to an embodiment of the disclosure.

### DETAILED DESCRIPTION

Below, an embodiment of the disclosure will be described in detail with reference to the accompanying drawings so that the disclosure may be readily implemented by one of ordinary skill in the technical field to which the disclosure pertains. However, the disclosure may be implemented in various different forms, and is not limited to the embodiments described herein. Also, in the drawings, portions irrelevant to the description are not shown in order to definitely describe the disclosure, and throughout the disclosure, similar parts are assigned like reference numerals. Also, in the entire drawings, like components are assigned like reference numerals.

In the disclosure, it will be understood that the case in which a certain portion is “connected” to another portion includes the case in which the portion is “electrically connected” to the other portion with another device in between, as well as the case in which the portion is “directly connected” to the other portion. Also, it will be understood that when a certain portion “includes” a certain component, the portion does not exclude another component but can further include another component, unless the context clearly dictates otherwise.

The phrases “in some embodiments” or “according to an embodiment” appearing in the disclosure do not necessarily indicate the same embodiment.

Some embodiments of the disclosure may be represented by functional block configurations and various processing operations. The entire or a part of the functional blocks may be implemented with various numbers of hardware and/or software configurations to execute specific functions. For example, the functional blocks of the disclosure may be implemented with one or more processors or microprocessors, or with circuitry configurations for performing intended functions.

Also, for example, the functional blocks of the disclosure may be implemented with various programming or scripting languages. The functional blocks may be implemented with algorithms that are executed by one or more processors. Also, the disclosure may adopt typical technologies for electronic environment settings, signal processing, and/or data processing. The terms “module”, “configuration”, etc. can be broadly used, and are not limited to mechanical and physical configurations.

Also, connection lines or connection members between components shown in the drawings are examples of functional connections and/or physical or circuital connections. In an actual apparatus, the connections between the components may be implemented in the form of various functional connections, physical connections, or circuital connections that can be replaced or added.

The expression ‘at least one of A, B or C’ indicates any one of only ‘A’, only ‘B’, only ‘C’, ‘both A and B’, ‘both A and C’, ‘both B and C’, or ‘A, B, and C’.

In an embodiment of the disclosure, an electronic apparatus may indicate any electronic apparatus capable of receiving content from a source apparatus and displaying a screen corresponding to the content. Herein, the content may be a game, a lecture, a movie, home training service content, etc.

The electronic apparatus according to an embodiment of the disclosure may be any electronic apparatus capable of selectively displaying at least one piece of content, and may include various types, such as a television (TV), a smart TV, a digital broadcast terminal, a tablet personal computer (PC), a smart phone, a mobile phone, a computer, a laptop computer, etc. Also, the display apparatus may be a fixed type, a mobile type, or a portable type that a user can carry.

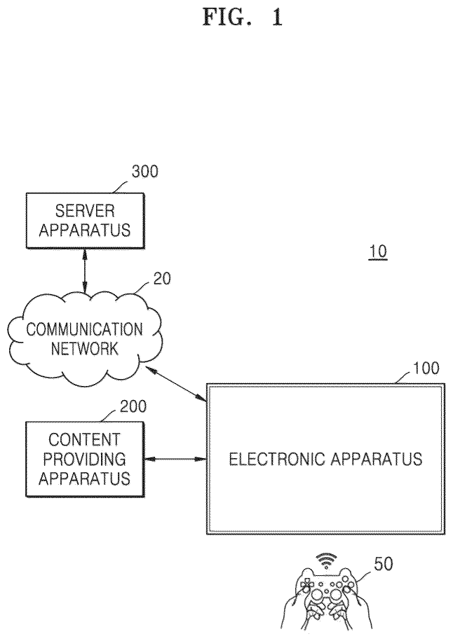

FIG. 1 shows an example of a system for playing content, according to an embodiment of the disclosure.

Referring to FIG. 1, a system 10 may include an electronic apparatus 100 that displays content, a content providing apparatus 200 or a server apparatus 300 that provides content, and an input apparatus 50.

The electronic apparatus 100 may communicate with the content providing apparatus 200 or the server apparatus 300, receive content provided from the content providing apparatus 200 or the server apparatus 300, and display the content.

The electronic apparatus 100 may transmit an execution request for a content application to the server apparatus 300, receive an execution result screen according to execution of the content application in response to the execution request from the server apparatus 300, and display the received execution result screen on a display. A user who uses the electronic apparatus 100 may control the input apparatus 50 to control the execution result screen displayed on the display of the electronic apparatus 100. According to a control by the user, the input apparatus 50 may transmit a control signal to the electronic apparatus 100, and the electronic apparatus 100 may transmit the control signal received from the input apparatus 50 to the server apparatus 300. The server apparatus 300 may execute the content application based on the control signal received from the electronic apparatus 100, and transmit an execution result screen to the electronic apparatus 100.

The electronic apparatus 100 may receive an execution result screen according to the execution of the content application from the content providing apparatus 200, and display the received execution result screen on the display. A user who uses the electronic apparatus 100 may control the input apparatus 50 to control the execution result screen displayed on the display of the electronic apparatus 100. According to a control by the user, the input apparatus 50 may transmit a control signal to the electronic apparatus 100, and the electronic apparatus 100 may transfer the control signal received from the input apparatus 50 to the content providing apparatus 200. The content providing apparatus 200 may execute the content application based on the control signal received from the electronic apparatus 100, and transmit an execution result screen to the electronic apparatus 100.

The content providing apparatus 200 may communicate with the electronic apparatus 100 according to wired communication technology or wireless communication technology. The content providing apparatus 200 may execute the content application, and transmit a result screen according to the execution of the content application to the electronic apparatus 100 through a communication network 20. For example, the content providing apparatus 200 may execute a game application, and transmit a result screen or a result image rendered according to the execution of the game application to the electronic apparatus 100.

The server apparatus 300 may execute a content application according to a request from the electronic apparatus 100, and transmit a result screen according to the execution of the content application to the electronic apparatus 100 through the communication network. For example, according to reception of an execution request for a game application from the electronic apparatus 100 by the server apparatus 300, the server apparatus 300 may execute the game application and transmit a result screen or a result image rendered according to the execution of the game application to the electronic apparatus 100 through a communication network 20.

While the electronic apparatus 100 receives game content according to execution of a game content application from the content providing apparatus 200 or the server apparatus 300 and displays the game content, the electronic apparatus 100 may set image quality or sound quality for outputting the game content differently according to characteristics of the game content. Game content may be produced to have various characteristics, such as providing overall dark images, providing overall bright images, providing fast images, or providing various effects, unlike general video content. Accordingly, the electronic apparatus 100 may provide audio and video output environments to better express such characteristics or effects of game content. For example, the electronic apparatus 100 may set image quality or sound quality for outputting game content according to a genre of the game content.

A related art method in which a user of the electronic apparatus 100 needs to manually set a genre of game content may cause the user's inconvenience. In the method requiring manual settings by a user, the user may need to make a setting through a control of a user interface (UI) provided in the electronic apparatus 100 while playing a game, which may hinder immersion in the game or make it difficult to optimize a setting for a content scene at the time of setting. Even though the electronic apparatus 100 is capable of automatically setting a genre of game content, such an automatic setting may be difficult in the case in which the electronic apparatus 100 is incapable of obtaining metadata about the genre of the game content. Embodiments of the disclosure may provide an electronic apparatus capable of recognizing, in the case of being incapable of obtaining metadata about a genre of game content, a representative genre of the content based on analysis of a played content screen, and an operating method of the electronic apparatus.

Game content may include characteristics of various genres, not characteristics of a single genre. For example, adventure game content may include both characteristics of an action genre and characteristics of a fighting genre for each scene. Accordingly, in game content, it may be important to provide various image quality and sound quality according to characteristics of each scene of the content in order to provide optimized image quality or sound quality at each moment of the scene. Characteristics of game content may change in the game content. Therefore, image quality or sound quality initially set based on only genre information of game content may not be suitable for a section in which characteristics of the game content have changed. Embodiments of the disclosure may provide an electronic apparatus capable of providing game content while adaptively changing image quality or sound quality according to characteristics of each scene of the game content, and an operating method of the electronic apparatus.

According to an embodiment of the disclosure, the electronic apparatus 100 may identify a representative genre of content based on information about the content and set image quality or sound quality for outputting the content based on one or more preset values corresponding to the identified representative genre. An output effect according to image quality or sound quality set based on a representative genre may be referred to as a primary audio visual effect. Also, the electronic apparatus 100 may identify a partial genre of the played content based on characteristics of the content obtained through scene analysis of the content, and assign a weight to the one or more preset values for setting image quality or sound quality in correspondence with the representative genre, according to the identified partial genre, thereby changing the image quality or sound quality for outputting the content. An output effect according to image quality or sound quality changed based on a partial genre may be referred to as a secondary audio visual effect.

According to an embodiment of the disclosure, the electronic apparatus 100 may identify a representative genre of content based on identification information of the content, and set at least one of video image quality or audio sound quality for playing the content to a preset value based on the identified representative genre, thereby providing the content with a primary audio visual effect.

According to an embodiment of the disclosure, the electronic apparatus 100 may identify a partial genre of the played content based on analysis of a scene including at least one video frame and/or an audio frequency corresponding to at least a part of the content and assign a weight to the preset value based on the identified partial genre, thereby providing the content with a secondary audio visual effect.

According to an embodiment of the disclosure, the electronic apparatus 100 may recognize that play of the content has begun, obtain a title of the played content by analyzing an image of the content, and identify a representative genre of the content based on the title of the content.

According to an embodiment of the disclosure, the electronic apparatus 100 may recognize that play of the content has begun, based on at least one signal among Variable Refresh Rate (VRR), Auto Low Latency Mode (ALLM), or ContentsType, received from an external apparatus connected to the electronic apparatus 100 to provide the content.

According to an embodiment of the disclosure, the electronic apparatus 100 may obtain at least one of a setting value of at least one parameter for setting video image quality or a setting value of at least one parameter for setting audio sound quality, corresponding to the representative genre, and set at least one of video image quality or audio sound quality by using the at least one of the setting value of the at least one parameter for setting video image quality or the setting value of the at least one parameter for setting audio sound quality.

According to an embodiment of the disclosure, the electronic apparatus 100 may obtain a genre selected from among a plurality of preset genres based on identification information of the content, as the representative genre of the content, and obtain a genre selected from among the plurality of preset genres based on analysis on a scene, as the partial genre of the content.

According to an embodiment of the disclosure, the electronic apparatus 100 may assign a weight to the primary audio visual effect by adjusting the setting value of the at least one parameter for setting video image quality, corresponding to the representative genre, by using an offset value corresponding to the identified partial genre.

According to an embodiment of the disclosure, the electronic apparatus 100 may be configured to obtain a table that stores the offset value that is added to the setting value of the at least one parameter for setting video image quality, corresponding to the representative genre, in correspondence with each of the plurality of preset genres, wherein the offset value may change within a preset range of values.

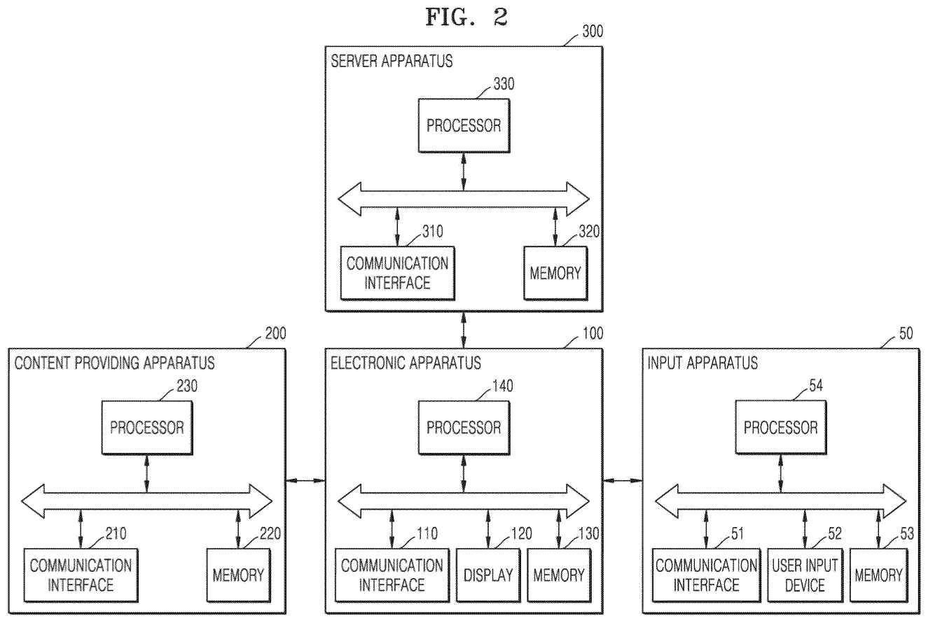

FIG. 2 shows an example of a schematic block diagram of apparatuses included in a system according to an embodiment of the disclosure.

Referring to FIG. 2, a system 10 may include the electronic apparatus 100 that displays content, the content providing apparatus 200 that provides content to the electronic apparatus 100, the server apparatus 300, and the input apparatus 50 that controls the electronic apparatus 100.

The electronic apparatus 100 may output or display content received from the content providing apparatus 200 or the server apparatus 300. The electronic apparatus 100 may include various types of electronic apparatuses, such as, for example, a network TV, a smart TV, an Internet TV, a web TV, an Internet Protocol Television (IPTV), and a PC, capable of receiving content and outputting the content. The electronic apparatus 100 may also be referred to as a display apparatus, in view of receiving content and displaying the content, and may also be referred to as a content receiving apparatus, a sync apparatus, a computing apparatus, etc.

The electronic apparatus 100 may be connected to the content providing apparatus 200 based on wired or wireless communication technology.

The electronic apparatus 100 and the content providing apparatus 200 may be connected to each other through a wired connection device for forming a wired network to perform content transmission/reception. For example, the wired connection device may include a cable, and each of the electronic apparatus 100 and the content providing apparatus 200 may include at least one port that is connected to the cable. The at least one port may include, for example, a High-Definition Multimedia Interface (HDMI) port, a display port, and a digital input interface such as type-C.

The electronic apparatus 100 and the content providing apparatus 200 may be connected to each other through a wireless connection device for forming a wireless network to perform content transmission/reception. For example, the wireless connection device may include a wireless HDMI communication module, and each of the electronic apparatus 100 and the content providing apparatus 200 may include a wireless HDMI communication module. As another example, the wireless connection device may include at least one communication module that performs communication according to a communication standard, such as Bluetooth, Wireless Fidelity (WiFi), Bluetooth Low Energy (BLE), Near Field Communication/Radio Frequency Identification (NFC/RFID), Wifi Direct, ultra-wideband (UWB), ZIGBEE, the Internet, 3G, 4G, 5G, and/or 6G.

The electronic apparatus 100 may be an apparatus capable of displaying images or data according to a request from a user, and include a communication interface 110, a display 120, memory 130, and a processor 140.

The communication interface 110 may perform communication with at least one external apparatus. Herein, ‘communication’ may mean an operation of transmitting and/or receiving data, signals, requests, and/or commands.

The communication interface 110 may perform wired or wireless communication with at least one external apparatus. The external apparatus may be the content providing apparatus 200 capable of providing content, the server apparatus 300, or the input apparatus 50.

For example, the communication interface 110 may include at least one among a communication module, communication circuitry, a communication apparatus, an input/output port, or an input/output plug for performing wired or wireless communication with at least one external apparatus.

For example, the communication interface 110 may include at least one wireless communication module, wireless communication circuitry, or a wireless communication apparatus for performing wireless communication with at least one external apparatus.

For example, the communication interface 110 may include a short-range communication module (for example, an infrared (IR) communication module) capable of receiving a control command from a remote controller located nearby, for example, the input apparatus 50. In this case, the communication interface 110 may receive a control signal from the remote controller.

As another example, the communication interface 110 may include at least one communication module that performs communication according to a wireless communication standard, such as Bluetooth, WiFi, BLE, NFC/RFID, WiFi Direct, UWB, or ZIGBEE. Alternatively, the communication interface 110 may further include a communication module that performs communication with a server for supporting long-distance communication according to a long-distance communication standard. For example, the communication interface 110 may include a communication module that performs communication through a network for Internet communication. Also, the communication interface 110 may include a communication module that performs communication through a communication network based on a communication standard, such as 3rd-generation (3G), 4th-generation (4G), 5th-generation (5G), and/or 6th-generation (6G).

As another example, the communication interface 110 may include at least one port that is connected to an external apparatus through a wired cable to communicate with the external apparatus by wire. For example, the communication interface 110 may include at least one of a High-Definition Multimedia Interface (HDMI) port, a component jack, a personal computer (PC) port, or a universal serial bus (USB) port. Accordingly, the communication interface 110 may perform communication with an external apparatus connected thereto by wire through the at least one port. Herein, the port may be a physical component into which a cable, a communication line, a plug, etc. is connectable or insertable.

As described above, the communication interface 110 may include at least one supporting element for supporting communication between the electronic apparatus 100 and an external apparatus. Herein, the supporting element may include the communication module, the communication circuitry, the communication device, the port (for inputting/outputting data), the cable port (for inputting/outputting data), the plug (for inputting/outputting data), etc., as described above. For example, examples of the at least one supporting element included in the communication interface 110 may be an Ethernet communication module, a Wifi communication module, a Bluetooth communication module, an IR communication module, a USB port, a tuner (or a broadcast receiver), a HDMI port, a display port (DP), a digital visual interface (DVI) port, etc.

Referring to FIG. 2, the electronic apparatus 100 may be an electronic apparatus that does not include a display therein. For example, the electronic apparatus 100 may be a set-top box (STB). As another example, the electronic apparatus 100 may be a content playback apparatus.

Alternatively, although the electronic apparatus 100 includes the display 120 therein, the electronic apparatus 100 may control content received by the electronic apparatus 100 or stored in the electronic apparatus 100 to be displayed through an external display connected through the communication interface 110, instead of the display 120. For example, the processor 140 may control the communication interface 110 to transmit content stored in the processor 140 or received through the communication interface 110 to the external display. For example, the communication interface 110 may transmit content to the external display according to a control by the processor 140. Then, the external display may output the received content through a display panel included therein. Accordingly, a user may visually recognize content output through the external display.

The display 120 may output an image on a screen according to a control by the processor 140. For example, the processor 140 may control the display 120 to output an intended image on the display 120.

The display 120 may output the image on the screen. For example, the display 120 may output an image corresponding to video data through a display panel included therein such that a user visually recognizes the video data. Moving image data forming moving image content may include a plurality of frame images, and the display 120 may play the moving image content by successively displaying the plurality of frame images according to a control by the processor 140. For example, the display 120 may output a content image corresponding to the moving image content on the screen according to a control by the processor 140.

Although the display 120 is shown as being arranged inside the electronic apparatus 100, the display 120 may be arranged outside the electronic apparatus 100 and connected to the electronic apparatus 100 through wired or wireless communication.

The memory 130 may store at least one instruction, data, information, and/or an application. For example, the memory 130 may store at least one instruction that is executed by the processor 140. For example, the memory 130 may store at least one program that is executed by the processor 140. For example, the memory 130 may store an application for providing a specified service.

The memory 130 may include at least one type of storage medium, among a flash memory type, a hard disk type, a multimedia card micro type, card type memory (for example, Secure Digital (SD) or eXtreme Digital (XD) memory), Random Access Memory (RAM), Static Random Access Memory (SRAM), Read-Only Memory (ROM), Electrically Erasable Programmable Read-Only Memory (EEPROM), Programmable Read-Only Memory (PROM), Magnetic Memory, a magnetic disk, or an optical disk.

The processor 140 may execute at least one instruction to perform an intended operation. Herein, the at least one instruction may be stored in internal memory included in the processor 140 or memory 130 included in the electronic apparatus 100 separately from the processor 140.

The processor 140 may control at least one component included in the electronic apparatus 100 to execute the at least one instruction to perform an intended operation. Accordingly, although a case in which the processor 140 performs specified operations is described as an example, the processor 140 may control at least one component included in the electronic apparatus 100 to perform the specified operations.

Also, although a case in which the processor 140 is provided as a single processor has been described and shown as an example, the processor 140 may include a plurality of processors.

For example, the processor 140 may include RAM that stores signals or data received from an outside of the electronic apparatus 100 or is used as a storage area corresponding to various tasks performed by the electronic apparatus 100, ROM storing a control program for controlling the electronic apparatus 100, an application for providing a specified function or service, and/or a plurality of instructions, and at least one processor. The processor 140 may include a Graphic Processing Unit (GPU) for processing graphics corresponding to video. The processor may be implemented as a System On Chip (SOC) into which a core and a GPU are integrated. Also, the processor 140 may include a multiple core, instead of a single core. For example, the processor 140 may include a dual core, a triple core, a quad core, a hexa core, an octa core, a deca core, a dodeca core, a hexa decimal core, etc.

In an embodiment of the disclosure, the processor 140 may store at least one instruction in the memory included therein and execute the at least one instruction stored in the memory included therein to perform a control of performing operations of the electronic apparatus 100. For example, the processor 140 may execute at least one instruction or program stored in the internal memory included therein or the memory 130 to perform a specified operation.

According to an embodiment of the disclosure, the processor 140 may execute the at least one instruction stored in the memory 130 to identify a representative genre of content based on information about the content.

According to an embodiment of the disclosure, the processor 140 may execute the at least one instruction stored in the memory 130 to set at least one of video image quality or audio sound quality for playing the content to a preset value based on the identified representative genre, thereby firstly performing video image quality control and/or audio sound quality control on the content.

According to an embodiment of the disclosure, the processor 140 may execute the at least one instruction stored in the memory 130 to identify a partial genre of the content based on analysis of a scene including at least one video frame and/or an audio frequency corresponding to at least a part of the played content.

According to an embodiment of the disclosure, the processor 140 may execute the at least one instruction stored in the memory 130 to apply a weight to the preset value based on the identified partial genre, thereby secondarily performing video image quality control and/or audio sound quality control on the content.

According to an embodiment of the disclosure, the processor 140 may execute the at least one instruction stored in the memory 130 to recognize that play of the content has begun, analyze an image of the played content to obtain title information of the content, and identify the representative genre of the content based on the title information of the content.

According to an embodiment of the disclosure, the processor 140 may execute the at least one instruction stored in the memory 130 to recognize that play of game content has begun, based on at least one signal of VRR, ALLM, or ContentsType received from an external apparatus connected to provide the content.

According to an embodiment of the disclosure, the processor 140 may execute the at least one instruction stored in the memory 130 to identify, as the representative genre of the content, a genre selected from among a plurality of preset genres based on the information about the content.

According to an embodiment of the disclosure, the processor 140 may execute the at least one instruction stored in the memory 130 to identify, as the partial genre of the content, a genre selected from among the plurality of preset genres based on the analysis of the scene.

According to an embodiment of the disclosure, the processor 140 may execute the at least one instruction stored in the memory 130 to obtain at least one of a setting value of at least one parameter for controlling video image quality or a setting value of at least one parameter for controlling audio sound quality, corresponding to the representative genre, and set at least one parameter for controlling video image quality by using the setting value of the at least one parameter for controlling video image quality or set at least one parameter for controlling audio sound quality by using the setting value of the at least one parameter for controlling audio sound quality, thereby controlling at least one of video image quality or audio sound quality.

According to an embodiment of the disclosure, the processor 140 may execute the at least one instruction stored in the memory 130 to adjust the setting value of the at least one parameter for setting video image quality and/or the setting value of the at least one parameter for setting audio sound quality, corresponding to the representative genre, by using a weight corresponding to the identified partial genre, thereby secondarily performing video image quality control and/or an audio image quality control on the content.

According to an embodiment of the disclosure, the processor 140 may execute the at least one instruction stored in the memory 130 to determine whether the identified partial genre is identical to the representative genre, perform, according to the identified partial genre being identical to the representative genre, video image quality control and/or audio sound quality control by using at least one of the setting value of the at least one parameter for controlling video image quality or the setting value of the at least one parameter for controlling audio sound quality, corresponding to the representative genre, and adjust, according to the identified partial genre being different from the representative genre, the setting value of the at least one parameter for controlling video image quality and/or the setting value of the at least one parameter for controlling audio sound quality, corresponding to the representative genre, by using the weight corresponding to the identified partial genre.

According to an embodiment of the disclosure, the processor 140 may execute the at least one instruction stored in the memory 130 to obtain a table that stores the weight that is added to the setting value of the at least one parameter for controlling video image quality, corresponding to the representative genre, in correspondence with each of the plurality of preset genres.

The electronic apparatus 100 may be any type of apparatus that includes a processor and memory to perform functions. The electronic apparatus 100 may be a fixed or portable apparatus. For example, the electronic apparatus 100 may include an apparatus that includes a display to display image content, video content, game content, graphic content, etc. The electronic apparatus 100 may output or display images or content received from the content providing apparatus 200 or the server apparatus 300. The electronic apparatus 100 may include various types of electronic apparatuses, such as a television including a network TV, a smart TV, an Internet TV, a web TV, and an IPTV, a computer including a desktop, a laptop, and a tablet, and various smart devices including a smart phone, a cellular phone, a game player, a music player, a video player, medical equipment, and a home appliance, capable of receiving content and outputting the content. The electronic apparatus 100 may also be referred to as a display apparatus, in view of receiving content and displaying the content, and may also be referred to as a content receiving apparatus, a sync apparatus, a display apparatus, a computing apparatus, etc.

The block diagram of the electronic apparatus 100 shown in FIG. 2 may be a block diagram for an embodiment. Components of the block diagram may be integrated into one body, another component may be added, or some of the components may be omitted, according to specifications of the electronic apparatus 100 actually implemented. For example, two or more components may be combined into one component, or one component may be subdivided into two or more components, as necessary. Also, a function that is performed in each block may be provided to describe embodiments of the disclosure, and a detailed operation or device for the function does not limit the scope of rights of the disclosure.

Hereinafter, the content providing apparatus 200 will be described.

The content providing apparatus 200 may be connected to the electronic apparatus 100 by using wired or wireless communication technology, and provide content to the electronic apparatus 100. The content providing apparatus 200 may execute a content application according to a request from the electronic apparatus 100, and transmit an execution result screen or an execution result image to the electronic apparatus 100. Also, the content providing apparatus 200 may receive an input signal for controlling the content application from the electronic apparatus 100. The content providing apparatus 100 may execute the content application based on the input signal and transmit an execution result screen or an execution result image to the electronic apparatus 100.

The content providing apparatus 100 may include a communication interface 210, memory 220, and a processor 230.

The communication interface 210 may include at least one module for enabling wired or wireless communication between the content providing apparatus 200 and the electronic apparatus 100.

According to an embodiment of the disclosure, the communication interface 210 may transmit content to the electronic apparatus 100 by performing communication with the electronic apparatus 100 according to wired communication technology or wireless communication technology. The wireless communication technology may include short-range communication technology. The short-range communication technology may include, for example, Bluetooth communication, Wifi communication, infrared communication, etc.

The memory 220 may store a program for processing and controlling the processor 230, and store data input to the content providing apparatus 200 or to be output from the content providing apparatus 200. Also, the memory 220 may store data required for operations of the content providing apparatus 200.

The memory 220 may include at least one type of storage medium, among a flash memory type, a hard disk type, a multimedia card micro type, card type memory (for example, SD or XD memory), RAM, SRAM, ROM, EEPROM, PROM, magnetic memory, a magnetic disk, or an optical disk.

The processor 230 may control overall operations of the content providing apparatus 200. For example, the processor 230 may execute at least one instruction stored in the memory 220 to perform functions of the content providing apparatus 200 as described in the disclosure.

According to an embodiment of the disclosure, the processor 230 may store at least one instruction in memory included therein and execute the at least one instruction stored in the memory included therein to perform a control of performing operations of the content providing apparatus 200. That is, the processor 230 may execute at least one instruction or program stored in internal memory included in the processor 230 or the memory 220 to perform a specified operation.

According to an embodiment of the disclosure, the processor 230 may execute the at least one instruction stored in the memory 220 to execute a content application and transmit an execution result screen to the electronic apparatus 100.

The content providing apparatus 200 may be any type of apparatus that includes a processor and memory to perform functions. For example, the content providing apparatus 200 may include various types of electronic apparatuses, such as a computer including a desktop, a laptop, and a tablet, and various smart devices including a smart phone, a cellular phone, a game player, a music player, a video player, medical equipment, and a home appliance, capable of executing a content application to provide content. The content providing apparatus 200 may also be referred to as a source apparatus, in view of providing content, and may also be referred to as an electronic apparatus, a computing apparatus, etc.

The block diagram of the electronic apparatus 100 shown in FIG. 2 may be a block diagram for an embodiment. Components of the block diagram may be integrated into one body, another component may be added, or some of the components may be omitted, according to specifications of the content providing apparatus 200 actually implemented. For example, two or more components may be combined into one component, or one component may be subdivided into two or more components, as necessary. Also, a function that is performed in each block may be provided to describe embodiments of the disclosure, and a detailed operation or device for the function does not limit the scope of rights of the disclosure.

Hereinafter, the server apparatus 300 will be described.

The server apparatus 300 may be connected to the electronic apparatus 100 by using wired or wireless communication technology, and provide content to the electronic apparatus 100. The server apparatus 300 may execute a content application according to a request from the electronic apparatus 100, and transmit an execution result screen or an execution result image to the electronic apparatus 100. Also, the server apparatus 300 may receive an input signal for controlling the content application from the electronic apparatus 100. The server apparatus 300 may execute the content application based on the input signal, and transmit an execution result screen or an execution result image to the electronic apparatus 100.

The server apparatus 300 may include various types of electronic apparatuses capable of providing content to the electronic apparatus 100. The server apparatus 300 may also be referred to as a source apparatus, in view of providing content, and may also be referred to as a host apparatus, a content providing apparatus, an electronic apparatus, a storage apparatus, a computing apparatus, a server computer, etc.

The server apparatus 300 may include a communication interface 310, memory 320, and a processor 330. However, the server apparatus 300 may be implemented by more components than those shown, without being limited to the above-described example. For example, the server apparatus 300 may include a separate image processor for image-processing an application image executed in the server apparatus 300.

The communication interface 310 may include one or more modules for enabling wireless communication between the server apparatus 300 and the electronic apparatus 100. According to an embodiment of the disclosure, the communication interface 310 may perform communication with the electronic apparatus 100 according to an Internet protocol. According to an embodiment of the disclosure, the communication interface 310 may perform communication with the input apparatus 50 according to an Internet protocol.

The memory 320 may store a program for processing and controls by the processor 330, and store data input to the server apparatus 300 or to be output from the server apparatus 300.

The memory 320 may include at least one type of storage medium, among a flash memory type, a hard disk type, a multimedia card micro type, card type memory (for example, SD or XD memory), RAM, SRAM, ROM, EEPROM, PROM, magnetic memory, a magnetic disk, or an optical disk.

The processor 330 may control overall operations of the server apparatus 300. For example, the processor 330 may execute at least one instruction stored in the memory 320 to perform functions of the server apparatus 300 as described in the disclosure.

According to an embodiment of the disclosure, the processor 330 may store at least one instruction in memory included therein and execute the at least one instruction stored in the memory included therein to perform a control of performing the above-described operations. That is, the processor 330 may execute at least one instruction or program stored in internal memory included in the processor 330 or the memory 320 to perform a specified operation.

According to an embodiment of the disclosure, the processor 330 may execute the at least one instruction stored in the memory 320 to receive a request for executing a content application from the electronic apparatus 100, and transmit an execution result screen of the content application requested to be executed to the electronic apparatus 100.

The block diagram of the server apparatus 300 shown in FIG. 2 may be a block diagram for an embodiment. Components of the block diagram may be integrated into one body, another component may be added, or some of the components may be omitted, according to specifications of the content providing apparatus 200 actually implemented. For example, two or more components may be combined into one component, or one component may be subdivided into two or more components, as necessary. Also, a function that is performed in each block may be provided to describe embodiments of the disclosure, and a detailed operation or device for the function does not limit the scope of rights of the disclosure.

Hereinafter, the input apparatus 50 will be described.

The input apparatus 50 may include a communication interface 51, a user input device 52, memory 53, and a processor 54. However, the input apparatus 50 may be implemented by more components than those shown, without being limited to the above-described example.

The communication interface 51 may include at least one module for enabling wired or wireless communication between the input apparatus 50 and the electronic apparatus 100. According to an embodiment of the disclosure, the communication interface 51 may perform communication with the electronic apparatus 100 according to short-range communication technology. The short-range communication technology may include, for example, Bluetooth communication, Wifi communication, infrared communication, etc. According to an embodiment of the disclosure, the communication interface 51 may perform communication with the server apparatus 300 according to an Internet protocol.

The user input device 52 may be any type of interface device capable of receiving a user input. For example, the user input device 52 may include a control button arranged in a part of the input apparatus 50 to receive a user's input, a touch sensitive display configured to detect a touch input, and a microphone capable of receiving a voice input uttered by a user.

According to an embodiment of the disclosure, the user input device 52 may receive a user input for controlling a game content execution result screen displayed on the display of the electronic apparatus 100 based on a control by the processor 54.

The memory 53 may store a program for processing and controls by the processor 54, and store data input to the input apparatus 50 or to be output from the input apparatus 50.

The memory 53 may include at least one type of storage medium among a flash memory type, a hard disk type, a multimedia card micro type, card type memory (for example, SD or XD memory), RAM, SRAM, ROM, EEPROM, PROM, magnetic memory, a magnetic disk, or an optical disk.

The processor 54 may control overall operations of the input apparatus 50. For example, the processor 54 may execute at least one instruction stored in the memory 53 to perform functions of the input apparatus 50 as described in the disclosure.

According to an embodiment of the disclosure, the processor 54 may store at least one instruction in memory included therein and execute the at least one instruction stored in the memory included therein to perform a control of performing the above-described operations. That is, the processor 54 may execute at least one instruction or program stored in internal memory included in the processor 54 or the memory 53 to perform a specified operation.

According to an embodiment of the disclosure, the processor 54 may execute the at least one instruction stored in the memory 53 to establish a communication connection to the electronic apparatus 100 by using short-range wireless communication technology. The short-range communication technology may include Bluetooth communication technology, Wifi Direct technology, infrared communication technology, etc.

According to an embodiment of the disclosure, the processor 54 may execute the at least one instruction stored in the memory 53 to control the communication interface 51 to transmit a control signal corresponding to a user input received through the user input device 52 to the electronic apparatus 100.

The input apparatus 50 may be any type of apparatus that includes a processor and memory to perform functions. The input apparatus 50 may include various electronic apparatuses, such as a remote controller, a game controller, a smart phone, etc.

The block diagram of the input apparatus 50 shown in FIG. 2 may be a block diagram for an embodiment. Components of the block diagram may be integrated into one body, another component may be added, or some of the components may be omitted, according to specifications of the input apparatus 50 actually implemented. For example, two or more components may be combined into one component, or one component may be subdivided into two or more components, as necessary. Also, a function that is performed in each block may be provided to describe embodiments of the disclosure, and a detailed operation or device for the function does not limit the scope of rights of the disclosure.

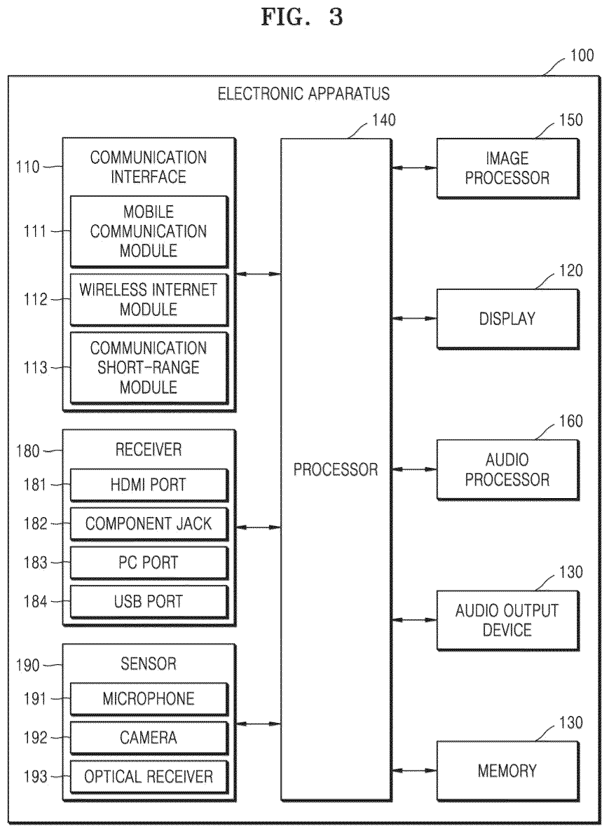

FIG. 3 shows an example of a block diagram of an electronic apparatus according to an embodiment of the disclosure.

Referring to FIG. 3, the electronic apparatus 100 may include an image processor 150, an audio processor 160, an audio output device 170, a receiver 180, and a sensor 190, in addition to the communication interface 110, the display 120, the memory 130, and the processor 140.

The communication interface 110 may include at least one module for enabling wireless communication between the electronic apparatus 100 and a wireless communication system or between the electronic apparatus 100 and a network where another electronic apparatus is located. For example, the communication interface 110 may include a mobile communication module 111, a wireless internet module 112, and a short-range communication module 113.

The mobile communication module 111 may transmit/receive a wireless signal to/from at least one of a base station, an external terminal, or a server on a mobile communication network. The wireless signal may include a voice call signal, a video call signal, or various formats of data according to transmission/reception of text/multimedia messages.

The wireless internet module 112 may be a module for wireless internet connections, and installed inside or outside the electronic apparatus 100. As wireless internet technology, wireless LAN (WLAN) (WiFi), Wireless broadband (Wibro), World Interoperability for Microwave Access (Wibro), High Speed Downlink Packet Access (HSDPA), etc. may be used. Through the wireless internet module 112, the electronic apparatus 100 may establish a WiFi Peer to Peer (P2P) connection to another device.

The short-range communication module 113 may be a module for short-range communication. As short-range communication technology, Bluetooth, BLE, RFID, Infrared Data Association (IrDA), UWB, ZigBee, etc. may be used.

The display 120 may display an image signal received from the server apparatus 300 on a screen.

The memory 130 may store programs related to operations of the electronic apparatus 100, and various data generated while the electronic apparatus 100 operates.

The memory 130 may store at least one instruction. Also, the memory 130 may store at least one program that is executed by the processor 140. Also, the memory 130 may store an application for providing a specified service.

The memory 130 may include at least one type of storage medium among a flash memory type, a hard disk type, a multimedia card micro type, card type memory (for example, SD or XD memory), RAM, SRAM, ROM, EEPROM, PROM, magnetic memory, a magnetic disk, or an optical disk.

The processor 140 may control overall operations of the electronic apparatus 100. For example, the processor 140 may execute at least one instruction stored in the memory 130 to perform functions of the electronic apparatus 100 as described in the disclosure.

According to an embodiment of the disclosure, the processor 140 may store at least one instruction in memory included therein and execute the at least one instruction stored in the memory included therein to perform a control of performing operations of the electronic apparatus 100. That is, the processor 140 may execute at least one instruction or program stored in internal memory included in the processor 140 or the memory 130 to perform a specified operation.

The processor 140 may perform functions of controlling overall operations of the electronic apparatus 100 and signal flow between the internal components of the electronic apparatus 100, and processing data. When a user's input is received or a condition set in advance and stored is satisfied, the processor 140 may execute Operating System (OS) and various applications stored in the memory 130.

The processor 140 may include a GPU for processing graphics corresponding to video. The GPU may generate a screen including various objects, such as an icon, an image, text, etc., by using a calculator and a rendering device. The calculator may calculate attribute values, such as coordinate values, shapes, sizes, colors, etc., of individual objects according to a layout of a screen by using a user interaction detected through the sensor. The rendering device may generate screens of various layouts including the objects, based on the attribute values calculated by the calculator.

The processor 140 may include various processing circuitry and/or a plurality of processors. For example, the term “processor” used herein, as well as in claims, may include various processing circuitry including at least one processor. In the at least one processor, one or more processors may be configured to perform various functions described herein individually and/or collectively in a distributed form. As used herein, the processor, the at least one processor, and the one or more processors may be configured to perform various functions. However, the terms may cover, for example, a situation in which a processor performs some of functions and another processor(s) performs other ones of the functions, and a situation in which a single processor performs all functions. Also, the at least one processor may include a combination of processors that perform various functions of the disclosed functions in a distributed manner. The at least one processor may execute program instructions for achieving or performing various functions.

The image processor 150 may process an image signal received from the receiver 180 or the communication interface 110 and output the processed result to the display 120, according to a control by the processor 140.

The audio processor 160 may convert an audio signal received from the receiver 180 or the communication interface 110 into an analog audio signal and output the analog audio signal to the audio output device 170, according to a control by the processor 140.

The audio output device 170 may output audio (for example, a voice or sound) received through the communication interface 110 or the receiver 180. Also, the audio output device 170 may output audio stored in the memory 130 according to a control by the processor 140. The audio output device 170 may include at least one or a combination of a speaker, a headphone output terminal, or a Sony/Philips Digital Interface (S/PDIF).

The receiver 180 may receive video (for example, a moving image, etc.), audio (for example, a voice, music, etc.), and additional information (for example, electronic program guide (EPG), etc.) from the outside of the electronic apparatus 100 according to a control by the processor 140. The receiver 180 may include one or a combination of a HDMI port 181, a component jack 182, a PC port 183, or a USB port 184. The receiver 180 may further include DP, Thunderbolt, and Mobile High-Definition Link (MHL), in addition to the HDMI port 181.

The sensor 190 may detect a user's voice, a user's image, or a user's interaction, and include a microphone 191, a camera 192, and a light receiver 193.

The microphone 191 may receive a voice uttered by a user. The microphone 191 may convert the received voice into an electrical signal and output the electrical signal to the processor 140. The user's voice may include, for example, a voice corresponding to a menu or function of the electronic apparatus 100.

The camera 192 may receive an image (for example, successive frames) corresponding to a user's motion including a gesture in a camera recognition range. The processor 140 may select a menu displayed on the electronic apparatus 100 using a result of recognition of the received motion, or perform a control corresponding to the result of the motion recognition.

A light receiver 193 may receive an optical signal (including a control signal) from an external control apparatus. The light receiver 193 may receive an optical signal corresponding to a user's input (for example, a touch, pressing, a touch gesture, a voice, or a motion) from a controller. A control signal may be extracted from the received optical signal according to a control by the processor 140.

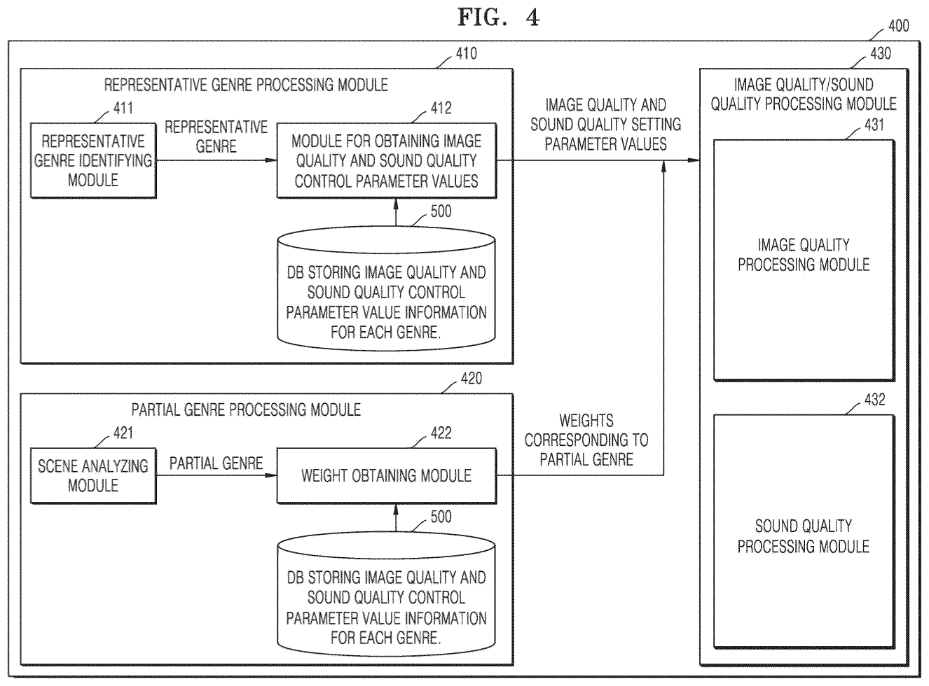

FIG. 4 shows a functional block diagram of an image quality/sound quality processing module that processes image quality and/or sound quality according to characteristics of a scene of content, according to an embodiment of the disclosure. The image quality/sound quality processing module shown in FIG. 4 may represent a block diagram illustrated in view of a function for performing operations based on one or more components among the components of the electronic apparatus 100 shown in FIG. 3.

Referring to FIG. 4, an image quality/sound quality processing module 400 may include a representative genre processing module 410 for enabling image quality/sound quality settings based on a representative genre identified from played content, a partial genre processing module 420 for enabling image quality/sound quality settings based on a partial genre identified from played content, and an image quality/sound quality processing module 430 for processing image quality/sound quality based on an output from the representative genre processing module 410 or an output from the partial genre processing module 420.

The representative genre processing module 410 may include a representative genre identifying module 411, a module 412 for obtaining an image quality and sound quality control parameter value, and a module 500 for storing image quality and sound quality control parameter value information for each genre.

The representative genre identifying module 411 may include an appropriate logic, circuitry, interface, and/or code configured to identify a representative genre of played content and provide information about the identified representative genre to the module 412 for obtaining the image quality and sound quality control parameter value.

According to an embodiment of the disclosure, the representative genre identifying module 411 may obtain metadata of played content and obtain information about a representative genre of the content from the metadata of the content. For example, a content producer or a content provider may provide content after including a representative genre about the content in metadata about the content. Accordingly, the representative genre identifying module 411 may identify a representative genre of content based on metadata about the content. For example, while the electronic apparatus 100 receives content from the server apparatus 300, the electronic apparatus 100 may receive metadata about the content from the server apparatus 300.

According to an embodiment of the disclosure, the representative genre identifying module 411 may obtain the information about the representative genre of the played content by obtaining identification information of the content such as a tile of the content from a frame of the content. For example, while the electronic apparatus 100 receives content from the content providing apparatus 200, the electronic apparatus 100 may fail to receive metadata of the content from the content providing apparatus 200. In this case, the representative genre identifying module 411 may obtain content identification information such as a title of the content by analyzing content of an output screen based on the content received from the content providing apparatus 200. Also, the representative genre identifying module 411 may obtain a representative genre of the content corresponding to the content identification information.

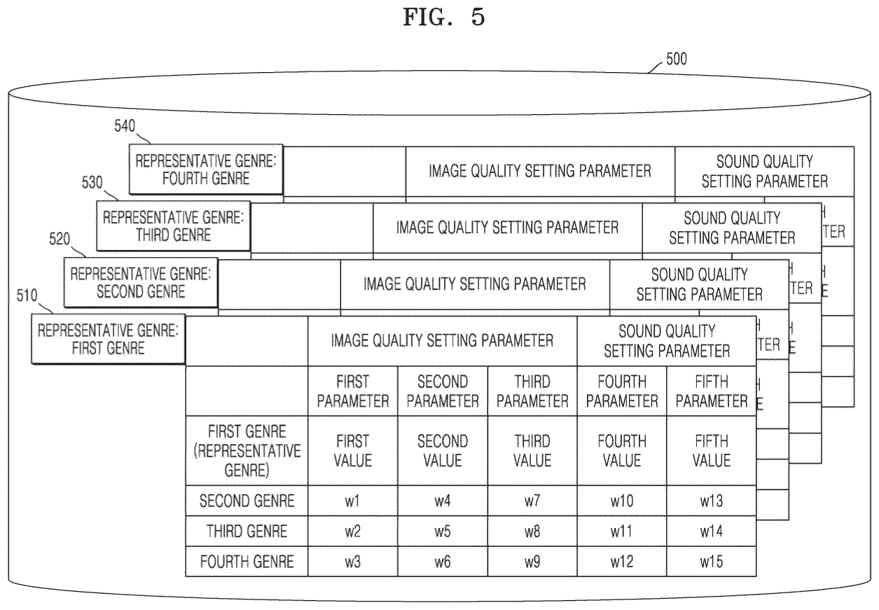

The module 412 for obtaining the image quality and sound quality control parameter value may include an appropriate logic, circuitry, interface, and/or code configured to obtain an image quality and sound quality control parameter value corresponding to the representative genre received from the representative genre identifying module 411 with reference to the module 500 for storing the image quality and sound quality control parameter value information for each genre as shown in FIG. 5.

FIG. 5 shows an example of a module for storing image quality and sound quality control parameter value information for each genre, according to an embodiment of the disclosure.

The module 500 for storing the image quality and sound quality control parameter value information for each genre may store parameter value information for image quality and sound quality settings for each of a plurality of genres of content.

Referring to FIG. 5, the module 500 for storing the image quality and sound quality control parameter value information for each genre may store a table corresponding to a representative genre of content. For example, the number of a plurality of genres of content may be four, and the plurality of genres may include a first genre, a second genre, a third genre, and a fourth genre. In this case, the table may include a first table 510 corresponding to the first genre as a representative genre, a second table 520 corresponding to the second genre as a representative genre, a third table 530 corresponding to the third genre as a representative genre, and a fourth table 540 corresponding to the fourth genre as a representative genre.

Each table may include an image quality control parameter and a sound control parameter for the corresponding genre. The image quality control parameter may be used to obtain desired image quality by adjusting details, clarity, color, contrast, etc. of an image, and may also be referred to as an image quality adjusting parameter. For example, the image quality control parameter may include at least one among Brightness for adjusting a total brightness level of an image, Contrast for adjusting a difference between a dark region and a bright region of an image by adjusting contrast of the image, Sharpness as a parameter for adjusting a sharpness level of an image, wherein high sharpness makes an image look clearer and low sharpness makes an image look softer, Color used to adjust a main color tone of an image, or Saturation used to change color vividness of an image by adjusting saturation of the image. The sound quality control parameter may be used to obtain desired sound by adjusting sound quality of audio, and may also be referred to a sound quality adjusting parameter. The sound quality control parameter may include, for example, at least one among Equalizer for adjusting sound quality by highlighting or suppressing a preset frequency band of music or an audio signal, Balance for adjusting a volume balance between a left channel and a right channel in a stereo audio system, Tone Control for adjusting pitch of low tone and high tone, Reverb and Echo used to provide an spatial effect by adding attenuated reflection sound to an audio signal, Volume Level (Gain) used to prevent excessive distortion or output a higher or lower signal by adjusting an input level of music or an audio signal, or Ambience Effects for providing a spatial effect or texture to an audio signal by adding Compression, Reverb, Chorus, Phaser, and other effects used to control a dynamic range of the audio signal.

Referring to FIG. 5, the image quality control parameter may include at least one parameter, for example, a first parameter, a second parameter, and a third parameter. The sound quality control parameter may include at least one parameter, for example, a fourth parameter and a fifth parameter.

For example, the first table 510 may represent that, to set image quality in correspondence with the first genre as a representative genre, the first parameter is set to a first value, the second parameter is set to a second value, and the third parameter is set to a third value, and to set sound quality, the fourth parameter is set to a fourth value and the fifth parameter is set to a fifth value. In the situation in which the representative genre is the first genre, the electronic apparatus may refer to the first table 510. In case the partial genre is identified as a second genre, the first table 510 may represent that, in this case, to change or update image quality settings, the first parameter is assigned a weight of w1, the second parameter is assigned a weight of w4, and the third parameter is assigned a weight of w7, and to change or update sound quality settings, the fourth parameter is assigned a weight of w10 and the fifth parameter is assigned a weight of w13. A weight corresponding to each partial genre may represent an offset value that is changeable based on a representative genre. That is, according to a representative genre being the first genre, the first parameter among the image quality control parameters may be set to the first value, and according to identifying of the second genre as a partial genre, the first parameter among the image quality control parameters may be set to first value+w1. A weight may be a value that is added to each parameter value, and may be set within a preset range for each parameter. For example, weights w1, w2, and w3 of the first parameter may have a value between −5 and +5, and for example, weights w4, w5, and w6 of the second parameter may have a value between −3 and +4.

Returning to FIG. 4, the module 412 for obtaining the image quality and sound quality control parameter value may obtain an image quality and sound quality control parameter value corresponding to a representative genre with reference to the module 500 for storing the image quality and sound quality control parameter value information for each genre, and provide the obtained image quality and sound quality control parameter value to the image quality/sound quality processing module 430.

The image quality/sound quality processing module 430 may include an image quality processing module 431 and a sound quality processing module 432.

The image quality processing module 431 may include an appropriate logic, circuitry, interface, and/or code configured to process image quality by setting an image quality control parameter based on a received image quality control parameter value.

The image quality control parameter may include at least one among a Brightness parameter for adjusting a total brightness level of an image, a Contrast parameter for adjusting a difference between a dark region and a bright region of an image by adjusting contrast of the image, a Sharpness parameter for adjusting a sharpness level of an image, a Color parameter used to adjust a main color tone of an image, or a Saturation parameter used to change color vividness of an image by adjusting saturation of the image. The image quality processing module 431 may control image quality by setting at least one image quality control parameter mentioned above based on a received image quality control parameter value.

The sound quality processing module 432 may include an appropriate logic, circuitry, interface, and/or code configured to process sound quality by setting a sound quality control parameter based on a received sound quality control parameter value.

The sound quality control parameter may include, for example, at least one among an Equalizer parameter for adjusting sound quality by highlighting or suppressing a preset frequency band of music or an audio signal, a Balance parameter for adjusting a volume balance between a left channel and a right channel in a stereo audio system, a Tone Control parameter for adjusting pitch of low tone and high tone, an Reverb and Echo parameter used to provide an spatial effect by adding attenuated reflection sound to an audio signal, a Volume Level (Gain) parameter used to prevent excessive distortion or output a higher or lower signal by adjusting an input level of music or an audio signal, or an Ambience Effects parameter for providing a spatial effect or texture to an audio signal by adding Compression, Reverb, Chorus, Phaser, and other effects used to control a dynamic range of the audio signal.

The sound quality processing module 432 may control sound quality by setting at least one sound quality control parameter mentioned above based on a received sound quality control parameter value.

The partial genre processing module 420 may include a scene analyzing module 421, a weight obtaining module 422, and the module 500 for storing the image quality and sound quality control parameter value information for each genre.

The scene analyzing module 421 may include an appropriate logic, circuitry, interface, and/or code configured to analyze a scene corresponding to at least one part of content played in the electronic apparatus 100 to identify a partial genre of the content and provide information about the identified partial genre to the weight obtaining module 422. The scene corresponding to the at least one part of the content may include video data and audio data.

The scene analyzing module 421 may analyze at least one video frame corresponding to at least one part of content played in the electronic apparatus 100.

The scene analyzing module 421 may analyze an audio frequency corresponding to at least one part of content played in the electronic apparatus 100.

The weight obtaining module 422 may include an appropriate logic, circuitry, interface, and/or code configured to obtain a weight for setting image quality and sound quality corresponding to a partial genre received from the scene analyzing module 421 with reference to the module 500 for storing the image quality and sound quality control parameter value information for each genre.

For example, referring to FIG. 5, in the situation in which a representative genre is the first genre, the partial genre may be identified as the third genre. In this case, the weight obtaining module 422 may obtain weights w2, w5, w8, w11, and w14 corresponding to the third genre from the first table 510 corresponding to the first genre as a representative genre.

Then, the weight obtaining module 422 may provide the weights corresponding to the partial genre to the image quality/sound quality processing module 430.

The image quality/sound quality processing module 430 may include the image quality processing module 431 and the sound quality processing module 432.

The image quality processing module 431 may include an appropriate logic, circuitry, interface, and/or code configured to process image quality by setting an image quality control parameter based on a received image quality control parameter value.

The sound quality processing module 432 may include an appropriate logic, circuitry, interface, and/or code configured to process sound quality by setting an sound quality control parameter based on a received sound quality control parameter value.

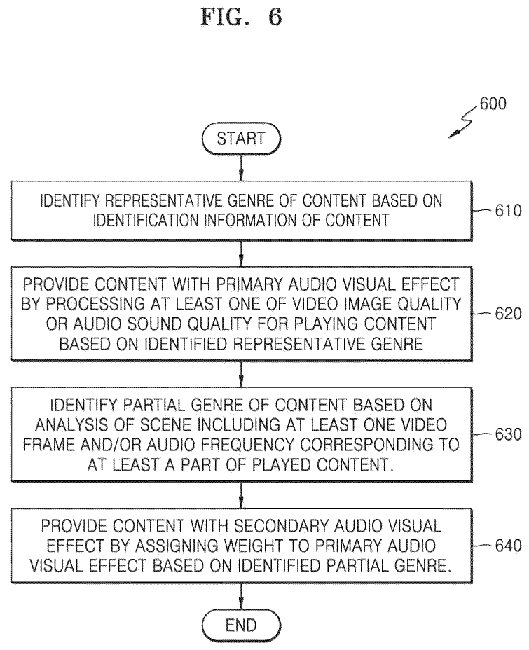

FIG. 6 shows an example of a flowchart illustrating an operating method of an electronic apparatus, according to an embodiment of the disclosure.

Referring to FIG. 6, in operation 610, the electronic apparatus 100 may identify a representative genre of content based on information about the content.

According to an embodiment of the disclosure, the electronic apparatus 100 may identify a representative genre of played content based on metadata of the content as information about the content. The metadata of the content may include various information about the content. For example, according to the content being game content, the metadata of the content may include information, such as a content title, a content identifier (ID), or a genre. For example, while the electronic apparatus 100 receives game content from the server apparatus 300 and displays the game content, the electronic apparatus 100 may receive metadata about the game content from the server apparatus 300. The electronic apparatus 100 may obtain genre information of the game content from the metadata about the game content. The electronic apparatus 100 may obtain the genre information of the game content based on a game content title included in the metadata. The electronic apparatus 100 may identify the obtained genre information of the game content as a representative genre of the content.

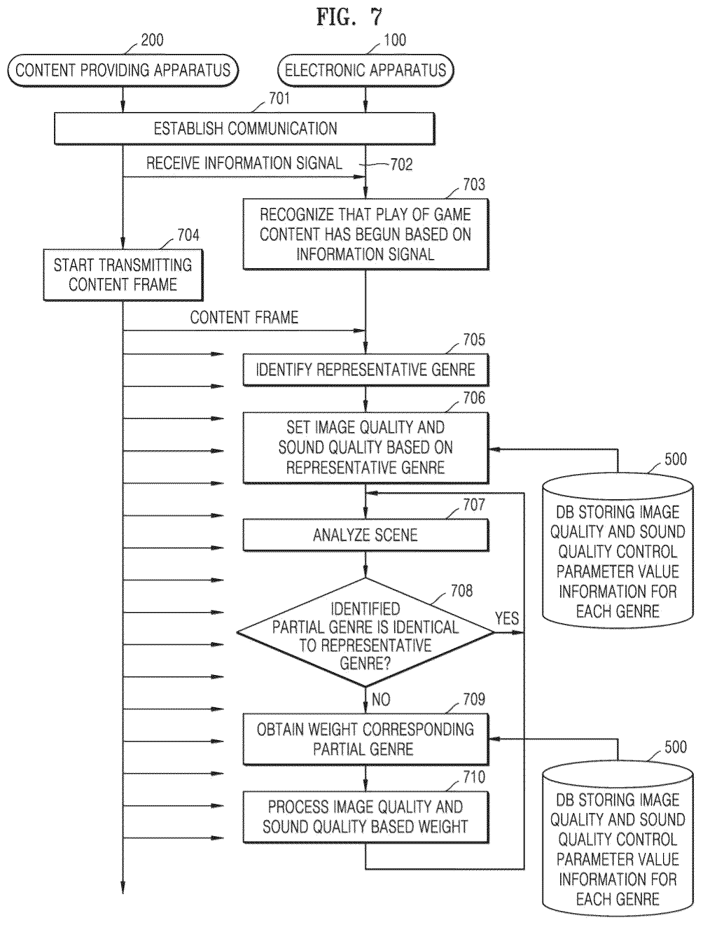

According to an embodiment of the disclosure, the electronic apparatus 100 may obtain, as information about played content, content identification information or a title of the content by analyzing a content screen displayed on the display, and identify a representative genre of the content based on the content identification information or the title of the content. For example, while the electronic apparatus 100 receives content from the content providing apparatus 200, the electronic apparatus 100 may fail to obtain metadata of the content. In this case, the electronic apparatus 100 may obtain content identification information or a title of the content by analyzing a content screen received from the content providing apparatus 200 and identify a representative genre of the content based on the content identification information or the title of the content. A method of identifying a representative genre of content by analyzing a content screen will be described in detail with reference to FIG. 7.

In operation 620, the electronic apparatus 100 may provide the content with a primary audio visual effect by processing at least one of video image quality or audio sound quality for playing the content based on the representative genre identified in operation 610.

According to an embodiment of the disclosure, the electronic apparatus 100 may provide the content with the primary audio visual effect by processing video image quality for playing the content based on the identified representative genre. For example, image quality processing may be aimed to enhance or improve image quality of video data, and may include at least one of color enhancement, brightness enhancement, contrast processing, or RGB correction. However, image processing methods that are performed by the electronic apparatus 100 are not limited to the above-mentioned examples.

According to an embodiment of the disclosure, the electronic apparatus 100 may provide the content with the primary audio visual effect by obtaining at least one image quality control parameter corresponding to the representative genre and processing video image quality for playing the content based on the at least one image quality control parameter. For example, the electronic apparatus 100 may obtain at least one image quality control parameter corresponding to the representative genre by using the module 500 for storing the image quality and sound quality control parameter value information for each genre as shown in FIG. 5. For example, according to the representative genre being identified as the first genre, the electronic apparatus 100 may obtain the first value, the second value, and the third value as image quality control parameters corresponding to the first genre from the first table 510 corresponding to the first genre in the module 500.

According to an embodiment of the disclosure, the electronic apparatus 100 may provide the content with the primary audio visual effect by processing audio sound quality for playing the content based on the identified representative genre. Sound quality processing may be aimed to enhance or improve sound quality of audio data. For example, according to a sports genre, audio sound quality may be improved appropriately for a sports environment by adding effects to sounds of the crowd or a player's game actions, for example, a sound of a player kicking the ball in the case of soccer and thus highlighting the sounds.

According to an embodiment of the disclosure, the electronic apparatus 100 may provide the content with the primary audio visual effect by obtaining at least one sound quality control parameter corresponding to the representative genre, and processing audio sound quality for playing the content based on the at least one sound quality control parameter. For example, the electronic apparatus 100 may obtain at least one sound quality control parameter corresponding to the representative genre by using the module 500 for storing the image quality and sound quality control parameter value information for each genre as shown in FIG. 5. For example, according to a representative genre being identified as the first genre, the electronic apparatus 100 may obtain the fourth value and the fifth value as sound quality control parameters corresponding to the first genre from the first table 510 corresponding to the first genre in the module 500 for storing the image quality and sound quality control parameter value information for each genre.

According to an embodiment of the disclosure, the electronic apparatus 100 may provide the content with the primary audio visual effect by processing video image quality and audio sound quality for playing the content based on the identified representative genre.

According to an embodiment of the disclosure, the electronic apparatus 100 may provide content with a primary audio visual effect by obtaining at least one image quality control parameter and at least one sound quality control parameter corresponding to a representative genre and processing video image quality and audio sound quality for playing the content based on the image quality control parameter and the sound quality control parameter. For example, the electronic apparatus 100 may obtain at least one image quality control parameter and at least one sound quality control parameter corresponding to a representative genre by using the module 500 for storing the image quality and sound quality control parameter value information for each genre as shown in FIG. 5. For example, according to a representative genre being identified as the first genre, the electronic apparatus 100 may obtain the first value, the second value, and the third value as image quality control parameters corresponding to the first genre and the fourth value and the fifth value as sound quality control parameters corresponding to the first genre, from the first table 510 corresponding to the first genre in the module 500 for storing the image quality and sound quality control parameter value information for each genre.

In operation 630, the electronic apparatus 100 may identify a partial genre of the content based on analysis of a scene including at least one video frame and/or an audio frequency corresponding to at least a part of the played content.

In operation 620, the electronic apparatus 100 may provide the primary audio visual effect corresponding to the representative genre for the content, thereby performing video quality processing and audio sound quality processing on the content to be suitable for main characteristics of the content. However, one piece of content may include various characteristics. For example, according to the representative genre being game content identified as Role Playing Game (RPG), a scene having characteristics of First Person Shooter (FPS) or SPORTS may be included in at least a part of the game content. Accordingly, after the electronic apparatus 100 performs image quality and sound quality processing based on the representative genre of RPG, the electronic apparatus 100 may detect a scene that may be classified into another genre, that is, a partial genre distinguished from the representative genre, and perform appropriate image quality and sound quality processing on the scene classified into the partial genre according to characteristics of the partial genre, thereby providing image quality and sound quality effects actively according to characteristics of the content. To this end, the electronic apparatus 100 may identify a partial genre of the played content by analyzing a scene including at least one video frame and/or an audio frequency corresponding to at least one part of the content.

According to an embodiment of the disclosure, the electronic apparatus 100 may identify a partial genre of the played content by analyzing at least one among brightness, saturation, a contrast ratio, sharpness or the number of objects of a screen of a scene including at least one video frame of the content. The electronic apparatus 100 may analyze video frames from a current streaming time to a previous preset time. For example, the electronic apparatus 100 may identify that a scene including at least one video frame corresponds to a genre of a plurality of preset genres according to a result of analysis of the scene, and set the genre to a partial genre.

According to an embodiment of the disclosure, a range or kinds of genre types used to set a partial genre may be identical to or different from a range or kinds of genre types used to set a representative genre. For example, according to a representative genre being set from among five preset genre types, partial genre types may include five genre types correspondingly. Alternatively, for example, in the case in which a representative genre is set from among five preset genre types, partial genre types may include ten genre types that are more than five.

According to an embodiment of the disclosure, in the case in which a game content provider provides information about a representative genre of game content and one or more genres to which the game content belongs, the electronic apparatus 100 may set the one or more genres provided by the game content provider to a range of partial genres, and identify a partial genre within the range of partial genres. For example, in the case in which a game content provider provides information indicating that genre information of certain game content belongs to four genres of RPG, RTS, FPS, and SPORTS and a representative genre of the game content is RPG, the electronic apparatus 100 may identify the representative genre of the game content as RPG and identify a partial genre of the game content from among RPG, RTS, FPS, and SPORTS.

According to an embodiment of the disclosure, the electronic apparatus 100 may identify characteristics of an audio scene of the played content by analyzing an audio frequency of the content. Characteristics of audio scenes may include, for example, effects, sports (crowd), music, speech, racing, etc. The electronic apparatus 100 may analyze frequencies of audio frames from a current streaming time to a previous preset time. The electronic apparatus 100 may identify a partial genre based on a result of analysis of the audio frequency of the played content.

According to an embodiment of the disclosure, the electronic apparatus 100 may identify a partial genre of the played content based on analysis of a scene including at least one video frame and an audio frequency corresponding to at least one part of the content. For example, according to a partial genre identified as a result of analysis of the video frame being identical to a partial genre identified as a result of analysis on the audio frequency, the partial genre may be set to a partial genre of the scene.

According to an embodiment of the disclosure, according to a partial genre identified as a result of analysis of the video frame being different from a partial genre identified as a result of analysis of the audio frequency, a partial genre may be set based on information of the representative genre. For example, according to a partial genre identified as a result of analysis of the video frame being RPG and a partial genre identified as a result of analysis of the audio frequency being Fighting, one of RPG or Fighting may be set to a partial genre according to what the representative genre is.

According to an embodiment of the disclosure, in the case in which a partial genre identified as a result of analysis of the video frame is different from a partial genre identified as a result of analysis of the audio frequency, a partial genre may be set based on more meaningful result information. For example, in the case in which a probability that a partial genre is identified as RPG based on a result of analysis of the video frame is 80% and probability that a partial genre is identified as Fighting according to a result of analysis of the audio frequency is 30%, the electronic apparatus 100 may set RPG having higher probability to a partial genre.

According to an embodiment of the disclosure, in the case in which a partial genre identified as a result of analysis of the video frame is different from a partial genre identified as a result of analysis of the audio frequency, the two partial genres may be used, instead of setting a single partial genre. A weight of an image quality control parameter corresponding to the partial genre identified as the result of analysis on the video frame and a weight of a sound quality control parameter corresponding to the partial genre identified as the result of analysis of the audio frequency may be obtained respectively. For example, according to a partial genre according to a result of analysis of the video frame being RPG and a partial genre according to a result of analysis of the audio frequency being Fighting, a weight of an image quality control parameter may be obtained to correspond to the partial genre of RPG and a weight of a sound quality control parameter may be obtained to correspond to the partial genre of Fighting.

In operation 640, the electronic apparatus 100 may provide the content with a secondary audio visual effect by assigning a weight to the primary audio visual effect based on the identified partial genre.

According to an embodiment of the disclosure, the electronic apparatus 100 may provide the content with the secondary audio visual effect by assigning a weight to the primary audio visual effect, that is, the at least one image quality control parameter and/or the at least one sound quality parameter set to process image quality and sound quality based on the representative genre.

According to an embodiment of the disclosure, the electronic apparatus 100 may provide the content with the secondary audio visual effect by assigning a weight to the primary audio visual effect, that is, the at least one image quality control parameter set to process image quality based on the representative genre.

According to an embodiment of the disclosure, the electronic apparatus 100 may provide the content with the secondary audio visual effect by obtaining a weight of at least one image quality control parameter corresponding to the partial genre and processing video image quality for playing the content based on the weight of the at least one image quality control parameter. For example, the electronic apparatus 100 may obtain at least one weight corresponding to the partial genre by using the module 500 for storing the image quality and sound quality control parameter value information for each genre as shown in FIG. 5. For example, according to the partial genre being identified as the second genre, the electronic apparatus 100 may obtain weights w1, w4, and w7 of image quality control parameters corresponding to the second genre from the first table 510 in the module 500 for storing the image quality and sound quality control parameter value information for each genre.

According to an embodiment of the disclosure, the electronic apparatus 100 may provide the content with the secondary audio visual effect by obtaining a weight of at least one sound quality control parameter corresponding to the partial genre and processing audio sound quality for playing the content based on the weight of the at least one sound quality control parameter. According to an embodiment of the disclosure, the electronic apparatus 100 may obtain at least one weight corresponding to the partial genre by using the module 500 for storing the image quality and sound quality control parameter value information for each genre as shown in FIG. 5. For example, according to the partial genre being identified as the second genre, the electronic apparatus 100 may obtain weights w10 and w13 of sound quality control parameters corresponding to the second genre from the first table 510 in the module 500.

According to an embodiment of the disclosure, the electronic apparatus 100 may provide the content with the secondary audio visual effect by obtaining weights of at least one image quality control parameter and at least one sound quality control parameter corresponding to the partial genre and processing video image quality and audio sound quality for playing the content based on the weights of the at least one image quality control parameter and the at least one sound quality control parameter. For example, the electronic apparatus 100 may obtain at least weight corresponding to the partial genre by using the module 500 for storing the image quality and sound quality control parameter value information for each genre as shown in FIG. 5. For example, according to the partial genre being identified as the second genre, the electronic apparatus 100 may obtain weights w1, w4, and w7 of image quality control parameters and weights w10 and w13 of sound quality control parameters corresponding to the second genre from the first table 510 in the module 500.

FIG. 7 shows an example of an operating method of an electronic apparatus, according to an embodiment of the disclosure.

Referring to FIG. 7, in operation 701, the electronic apparatus 100 may establish communication with the content providing apparatus 200. According to an embodiment of the disclosure, the electronic apparatus 100 may establish communication with the content providing apparatus 200 through a HDMI port.

In operation 702, the electronic apparatus 100 may receive an information signal from the content providing apparatus 200. For example, the electronic apparatus 100 may receive an information signal, such as VRR, ALLM, ContentsType, etc., from a game console or a PC connected thereto through the HDMI port.

VRR means a variable refresh rate, a screen refresh rate, or a variable playback rate, and may represent information indicating technology for synchronizing the frame per seconds (fps) of a game with the refresh rate (Hz) of a monitor. For example, according to the content providing apparatus 200 being a PC, each graphic card vender may make VRR output settings, and the electronic apparatus 100 may receive a VRR signal from the content providing apparatus 200 according to the output settings.

The ALLM is an abbreviation of Auto Low Latency Mode, and may represent technology for reducing delay time between an input to a controller and an output in a game. Supporting ALLM reduces an input delay and generates a smooth screen, thereby enabling a user to play a game with the smooth screen without any interruption to the screen. According to communication establishment based on the HDMI 2.1, the electronic apparatus 100 may receive an ALLM information signal from the content providing apparatus 200.

According to the content providing apparatus 200 being a game console, the content providing apparatus 200 may continue to transmit, to the electronic apparatus 100, at least one of information signals, such as ALLM, VRR, Contents Type (Video/Game), etc., depending on whether game content is played.

In operation 703, the electronic apparatus 100 may recognize that play of the game content has begun, based on the information signal. The electronic apparatus 100 may recognize that play of the game content has begun, based on the information signal received from the content providing apparatus 200, for example, at least one of signals, such as ALLM, VRR, or ContentsType. That is, according to reception of at least one of ALLM, VRR, or ContentsType (Video/Game) from the content providing apparatus 200, the electronic apparatus 100 may recognize that play of the game content has begun. Likewise, when at least one of signals of ALLM, VRR, or ContentsType (Video/Game) is no longer received from the content providing apparatus 200, the electronic apparatus 100 may recognize that play of the game content has ended. As such, according to recognition that play of the game content has begun, the electronic apparatus 100 may prepare to identify a representative genre by analyzing a content frame image received from the content providing apparatus 200.

In operation 704, according to the content providing apparatus 200 starting transmitting a content frame, the electronic apparatus 100 may receive a content frame image from the content providing apparatus 200.

In operation 705, the electronic apparatus 100 may detect a representative genre based on the content frame image received from the content providing apparatus 200.

According to an embodiment of the disclosure, the electronic apparatus 100 may recognize attribute information of the game content being executed based on a content capture screen input to a neural network model trained in advance through deep learning, and recognize a representative genre based on the attribute information of the game content. The neural network model may include a model trained to receive a plurality of image screens as training data and detect text regions from the image screens. An algorithm or a group of algorithms for embodying Al technology is called a neural network. The neural network may receive input data, analyze the input data, and output desired result data. For the neural network to correctly output result data corresponding to input data, the neural network may need to be trained. Herein, ‘training’ may mean training a neural network to enable the neural network to itself discover and learn a method of inputting various data to the neural network and analyzing the input data, a method of classifying input data, and/or a method of extracting features required to generate result data from input data. Herein, ‘training’ may also be expressed as ‘learning’. Also, a group of algorithms for outputting output data corresponding to input data through the above-described neural network, software for executing the group of algorithms, and/or hardware for executing the group of algorithms may be referred to as an ‘AI model’ (also, referred to as an ‘artificial intelligence model’). The AI model may exist in very various forms. There may be various AI models for performing operations of receiving an image, analyzing the image, and classifying a gesture of an object included in the image into at least one class. An AI model may include at least one neural network.

For example, methods for performing object recognition, object tracking, and/or object classification using AI technology that performs calculations through a neural network are being developed and used. Hereinafter, for convenience of description, operations for performing object recognition, object tracking and object classification to recognize a preset image object by analyzing an image are collectively referred to as ‘object recognition’. For example, the neural network may include a Deep Neural Network (DNN) that includes a plurality of layers and performs multi-stage operations. Also, a DNN operation may include a Convolutional Neural Network (CNN) operation. A data recognition module for object recognition may be embodied through an exemplary neural network, and the embodied data recognition model may be trained by using training data. Then, input data, for example, an input image may be analyzed by using the trained data recognition model to recognize an object from the input image, and the recognized object may be output as output data. Also, the CNN refers to any neural network that performs an algorithm of finding patterns by analyzing images, and the CNN may have various types and forms.

According to an embodiment of the disclosure, the electronic apparatus 100 may input an image screen to a neural network model and analyze the image screen to thus extract a text region from the image screen, and obtain attribute information of content based on the text region. The attribute information of the content may include information about a representative genre of the content.

According to an embodiment of the disclosure, the electronic apparatus 100 may obtain the attribute information of the content by transmitting text extracted from the text region to a server and receiving the attribute information of the content related to the text from the server.

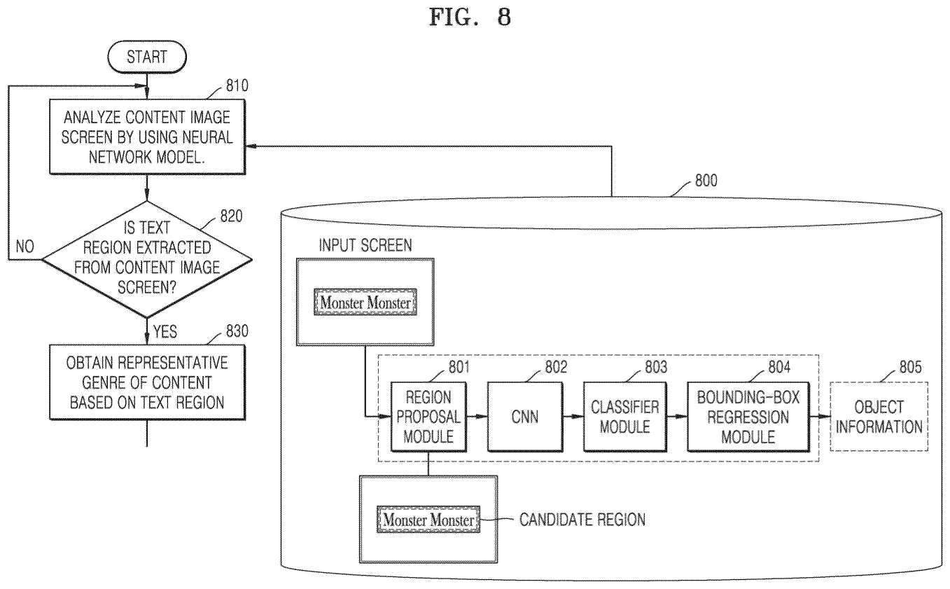

FIG. 8 is a reference view for describing a method of recognizing content by analyzing a content image screen in an electronic apparatus, according to an embodiment of the disclosure.

Referring to FIG. 8, in operation 810, the electronic apparatus 100 may analyze a content image screen by using a neural network model. The neural network model may be a neural network used to detect at least one object from an input image, and the neural network model may include, for example, two stage methods algorithms, such as Fast Region-based Convolutional Neural Network (Fast R-CNN), Region-based Fully Convolutional Network (R-FCN), and Feature Pyramid Network-Full Resolution Convolutional Network (FPN-FRCN), or single stage methods algorithms, such as You Only Look Once (YOLO), Single Shot Multibox Detector (SSD), and RetinaNet. According to an embodiment of the disclosure, the neural network model may include an object detection model 800 for detecting an object including text from an input screen by training a plurality of input images including text.

The object detection model 800 may detect at least one object from an input image by using at least one neural network, and output object information including an object class and an object location corresponding to the detected object.

Object detection may be determining locations of objects in a given image (object localization) and classifying a category to which each object belongs (object classification). Accordingly, an object detection model may be generally subject to three stages, that is, informative region selection of selecting an object candidate region, feature extraction of extracting a feature from each candidate region, and classification of applying a classifier to the extracted feature to classify a class of the object candidate region. According to detection methods, localization performance may be improved through post-processing such as bounding-box regression.

Referring to FIG. 8, as an example of the object detection model 800, a network structure of R-CNN which is an object detection method as a combination of region proposal and CNN is shown.

Referring to FIG. 8, the object detection model 800 may include a region proposal module 801, CNN 802, a classifier module 803, and a bounding-box regression module 804.

The region proposal module 801 may extract a candidate region from an input image. A preset number of candidate regions, for example, 2000 candidate regions may be extracted. R-CNN may use selective-search as one of region proposal algorithms.

The CNN 802 may extract a fixed-length feature vector from the candidate region generated by the region proposal module 801. Because the CNN (for example, AlexNet, VggNet, etc.) receives inputs having a preset size, the region proposal algorithm may need to warp various rectangular-shaped regions of images regardless of sizes or aspect ratios to adjust the images to the preset size. The CNN may receive a wrapped region and extract a result of a layer before the classifier module 803.

The classifier module (for example, Linear svm module) 803 may receive the fixed-length feature vector as an input and perform classification. For example, the classifier module 803 may determine whether an object corresponds to a text or a logo.

The bounding-box regression module 804 may receive the fixed-length feature vector as an input and calculate four numbers x, y, w, and h that express a box. A location of an object may be specified by four numbers x, y, w, and h that express a box.

That is, R-CNN may perform object detection by performing localization of an object through region proposal extraction and recognizing a class of the object through classification of an extracted feature. Then, by performing bounding-box regression, a process of reducing localization errors may be performed.

The training of the object detection model 800 may change, to modify CNN trained in advance to be suitable for an object detection task, a classification layer (for example, an output layer) in the CNN trained in advance to “the number of object classes+background” for new object detection, and perform weight initialization only on the corresponding part.

For example, at least one object may be detected from an input image by such an object detection model. Object information 805 may include information about at least one object, and each piece of object information may be expressed by (object class, location). Herein, the object class may represent text.

In operation 820, the electronic apparatus 100 may determine whether a text region has been extracted from the content image screen.

In the case in which it is determined in operation 820 that no text region has been detected from the content image screen, the process may proceed to operation 810 to analyze a next screen.

In the case in which it is determined in operation 820 that a text region has been detected from the content image screen, the process may proceed to operation 830.

In operation 830, the electronic apparatus 100 may obtain a representative genre of the content based on the detected text region.

According to an embodiment of the disclosure, in the case in which the electronic apparatus 100 detects a text region from the content image screen, the electronic apparatus 100 may extract a text from the text region and obtain attribute information of the content based on the extracted text. The electronic apparatus 100 may extract the text from the text region by using technology such as Optical Character Recognition (OCR). The electronic apparatus 100 may transmit the text extracted from the text region to a server that manages information about content, and receive attribute information of content corresponding to the text from the server. For example, the server may receive the text from the electronic apparatus 100, search for content corresponding to the text, extract, when finding information about the corresponding content, the information about the content, that is, attribute information, such as a category, a genre, viewing age information, etc. of the content, and transmit the extracted attribute information of the content to the electronic apparatus 100. The electronic apparatus 100 may identify a genre included in the attribute information of the content as a representative genre of the content.

Referring again to FIG. 7, in operation 706, the electronic apparatus 100 may process image quality and sound quality based on the identified representative genre.

According to an embodiment of the disclosure, the electronic apparatus 100 may store at least one image quality control parameter value and/or at least one sound quality control parameter value corresponding to each genre of a plurality of preset genre. Then, the electronic apparatus 100 may obtain at least one image quality control parameter value and/or at least one sound quality control parameter value corresponding to the representative genre from among the plurality of preset genres. Then, the electronic apparatus 100 may process image quality and/or sound quality by setting at least one image quality control parameter and/or at least one sound quality control parameter based on the at least one image quality control parameter value and/or the at least one sound quality control parameter value.

According to an embodiment of the disclosure, the electronic apparatus 100 may perform image quality and/or sound quality processing corresponding to the representative genre by using the module 500 for storing the image quality and sound quality control parameter value information for each genre as shown in FIG. 5. For example, according to the content being game content, the plurality of preset genres may include RPG in which users enjoy playing characters in the game, FPS in which players involve fighting using weapons or tools on a screen at the players' points of view or the persons' points of view, RTS in which users collect resources, build buildings or produce troops with the resources, and finish the game when developing a civilization or winning a war, and SPORTS. For example, in the module 500 for storing the image quality and sound quality control parameter value information for each genre as shown in FIG. 5, each of the first genre, the second genre, the third genre, and the fourth genre may be any one of RPG, FPS, RTS, and SPORTS.

For example, according to the identified representative genre being the first genre, the electronic apparatus 100 may obtain the first table 510 corresponding to the first genre as the representative genre from the module 500 for storing the image quality and sound quality control parameter value information for each genre. Then, the electronic apparatus 100 may perform image quality processing by setting a first parameter, a second parameter, and a third parameter according to the first value as a setting value of the first parameter, the second value as a setting value of the second parameter, and the third value as a setting value of the third parameter, which are image quality control parameters corresponding to the first genre, in the first table 510. Also, the electronic apparatus 100 may perform sound quality processing by setting a fourth parameter and a fifth parameter according to the fourth value as a setting value of the fourth parameter and the fifth value as a setting value of the fifth parameter, which are sound quality control parameters corresponding to the first genre, in the first table 510.

For example, a first-person shooting game such as FPS may require a higher level of realism than other games because a view point of a character in the game needs to be identical to a player's view point, and therefore, third image quality values composed of image quality values capable of expressing relatively more realism may be set.

In operation 707, the electronic apparatus 100 may perform scene analysis based on a content frame received from the content providing apparatus 200.

According to an embodiment of the disclosure, the electronic apparatus 100 may perform analysis of a screen based on a video frame of content received from the content providing apparatus 200. For example, the electronic apparatus 100 may analyze brightness, saturation, a contrast rate, sharpness, the number of objects, etc. of the screen by using a frame analysis engine or a scene analysis engine. Then, the electronic apparatus 100 may identify a genre from among a plurality of preset genres based on the analyzed result. The genre identified by the electronic apparatus 100 based on the scene analysis may be referred to as a partial genre that is distinguished from a representative genre.

According to an embodiment of the disclosure, the electronic apparatus 100 may perform analysis of an audio frequency based on an audio frame of the content received from the content providing apparatus 200. For example, the electronic apparatus 100 may analyze frequencies of audio frames from a current streaming time to a previous preset time by using an audio frequency analysis engine, etc., thereby identifying a category to which the corresponding audio scene belongs. For example, categories of audio scenes may include effect, sports, music, speech, racing, etc. The electronic apparatus 100 may determine enhancement levels of sound elements, such as Speech Intelligibility, Presence, Tonal Balance, Sound Stage, and Surround, according to the identified category of the audio scene.

In operation 708, the electronic apparatus 100 may determine whether the identified partial genre is identical to the representative genre identified in operation 705. According to the identified partial genre being identical to the representative genre identified in operation 705, the image quality or sound quality parameters set based on the current representative genre may not need to change, and therefore, the process may proceed to operation 707 to analyze a next scene.

In operation 708, according to the identified partial genre being not identical to the representative genre identified in operation 705, the image quality or sound quality parameters set based on the current representative genre may need to change to be suitable for the identified partial genre, and therefore, the process may proceed to operation 709.

In operation 709, the electronic apparatus 100 may obtain a weight for an image quality control parameter and/or a sound quality control parameter corresponding to the identified partial genre.

According to an embodiment of the disclosure, the electronic apparatus 100 may obtain the weight for the image quality control parameter and/or the sound quality control parameter corresponding to the identified partial genre with reference to the module 500 for storing the image quality and sound quality control parameter value information for each genre. For example, referring to FIG. 5, in the case in which a representative genre of content being currently played is the first genre and an identified partial genre is the third genre, the electronic apparatus 100 may obtain weights w2, w5, and w8 for a first parameter, a second parameter, and a third parameter as image quality control parameters corresponding to the third genre, and obtain weights w11 and w14 for a fourth parameter and a fifth parameter as sound quality control parameters corresponding to the third genre, from the first table 510 corresponding to the first genre as the representative genre.

In operation 710, the electronic apparatus 100 may perform image quality and sound quality processing based on the obtained weights.

According to an embodiment of the disclosure, the electronic apparatus 100 may perform image quality processing by setting image quality control parameters by using the weights for the image quality control parameters. For example, in the above example, according to the electronic apparatus 100 obtaining w2, w5, and w8 as the weights for the first parameter, the second parameter, and the third parameter which are the image quality control parameters, the electronic apparatus 100 may set parameters by applying w2, w5, and w8 to the first parameter, the second parameter, and the third parameter, respectively. Applying w2 to the first parameter may mean processing of reflecting the weight w2 to a value currently set for the first parameter. For example, applying w2 to the first parameter may mean adding the weight w2 to the first value which is a value currently set for the first parameter.

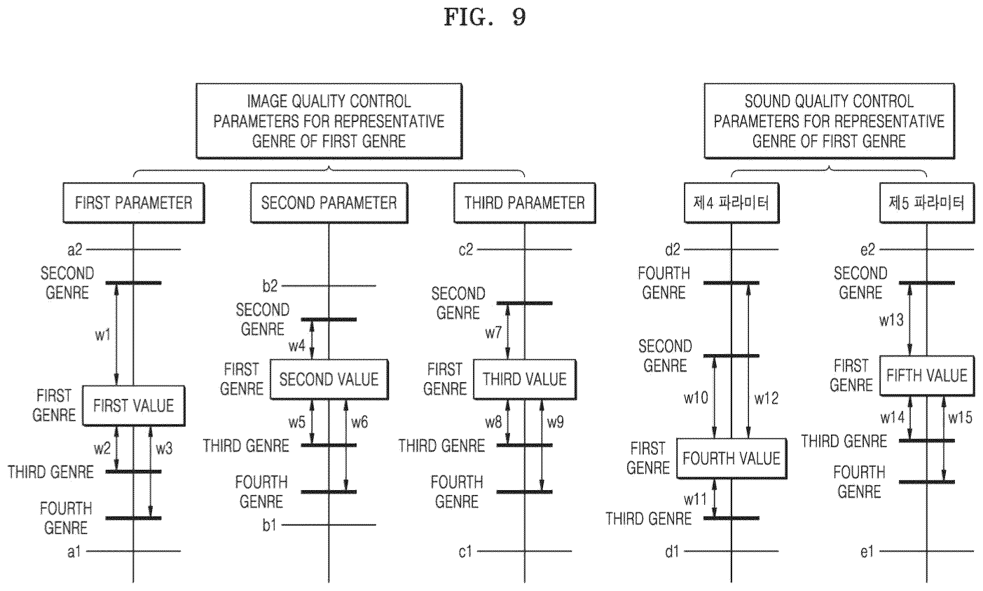

According to an embodiment of the disclosure, the electronic apparatus 100 may perform sound quality processing by setting a sound quality control parameter by using a weight for the sound quality control parameter. For example, in the above example, according to the electronic apparatus 100 obtaining w11 and w14 as the weights for the fourth parameter and the fifth parameter which are the sound quality control parameters, the electronic apparatus 100 may set parameters by applying w11 and w14 to the fourth parameter and the fifth parameter, respectively. Applying w11 to the fourth parameter may mean processing of reflecting the weight w11 to a value currently set for the fourth parameter. For example, applying w11 to the fourth parameter may mean adding the weight w11 to the fourth value which is a value currently set for the fourth parameter. A method of applying a weight to an image quality control parameter or a sound quality control parameter will be described with reference to FIG. 9.

FIG. 9 is a reference view for describing an example of applying weights to an image quality control parameter and a sound quality control parameter, according to an embodiment of the disclosure. The example shown in FIG. 9 relates to examples of weights for image quality control parameters and sound quality control parameters corresponding to the first genre as a representative genre.

Referring to FIG. 9, according to a representative genre being the first genre, the image quality control parameters may include a first parameter, a second parameter, and a third parameter, and the sound quality control parameters may include a fourth parameter and a fifth parameter.

Each parameter may be mapped to a preset value set for a representative genre of content. For example, according to a representative genre being identified as the first genre, the first parameter may be set to a first value, the second parameter may be set to a second value, the third parameter may be set to a third value, the fourth parameter may be set to a fourth value, and the fifth parameter may be set to a fifth value.

According to a partial genre identified after the representative genre of the content is identified as the first genre being identified as the second genre, the third genre, or the fourth genre, the electronic apparatus 100 may adjust or change image quality or sound quality by applying weights mapped to the respective parameters.

For example, the first parameter may be set to the first value in correspondence with the first genre as the representative genre, and a weight for the partial genre may be set in a range of a1 to a2. The second parameter may be set to the second value in correspondence with the first genre as the representative genre, and a weight for the partial genre may be set in a range of b1 to b2. The third parameter may be set to the third value in correspondence with the first genre as the representative genre, and a weight for the partial genre may be set in a range of c1 to c2. The fourth parameter may be set to the fourth value in correspondence with the first genre as the representative genre, and a weight for the partial genre may be set in a range of d1 to d2. The fifth parameter may be set to the fifth value in correspondence with the first genre as the representative genre, and a weight for the partial genre may be set in a range of e1 to e2.

In the case of the first parameter, a weight corresponding to each partial genre may represent a relative value based on the first value. A weight corresponding to the second genre as the partial genre may be w1, a weight corresponding to the third genre may be w2, and a weight corresponding to the fourth genre may be w3. Each of w1, w2, and w3 may be set in the range of a1 to a2. For example, a1 may be −3 and a2 may be +3. In this case, each of w1, w2, and w3 may be set in a range of −3 to +3. For example, the first value may be 15, and w1, w2, and w3 may be +2, −1, and −2, respectively. In this case, according to a representative genre of content being identified as the first genre, the electronic apparatus 100 may set the first parameter to 15 which is the first value. Thereafter, according to a partial genre being identified as the third genre based on a result of scene analysis of the content, the electronic apparatus 100 may obtain −1 as the weight w2 corresponding to the third genre, and set the first parameter to a value (15+(−1))=14 resulting from adding the weight w2 to the first value as a current setting value of the first parameter.

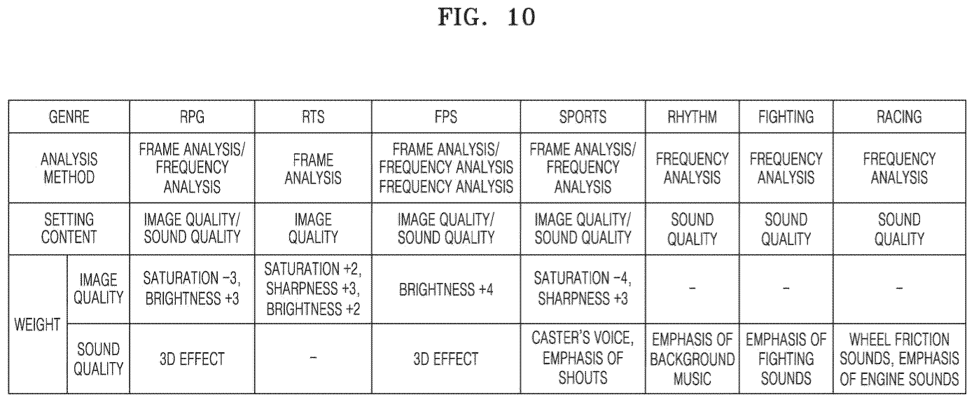

FIG. 10 is a reference view for describing an example of analyzing and processing image quality or sound quality for each genre of game content, according to an embodiment of the disclosure.

In the example shown in FIG. 5, an example of controlling both image quality and sound quality with respect to all genres has been described. However, according to genes of game content, only image quality may be controlled, only sound quality may be controlled, or both image quality and sound quality may be controlled.

Referring to FIG. 10, a plurality of preset genres may include RPG, RTS, FPS, SPORTS, Rhythm, Fighting, and Racing.

As results of frame image analysis and audio frequency analysis after play of game content has begun, a partial genre may be identified as RPG. In this case, the electronic apparatus 100 may control both image quality and sound quality according to the analyzed results. In this case, weights for controlling image quality may be saturation of −3 and brightness of +3, and weights for controlling sound quality may represent a three-dimensional (3D) effect. That is, the electronic apparatus 100 may control image quality by adding −3 to a current setting value of a saturation parameter and adding +3 to a current setting value of a brightness parameter, and perform a sound quality control by adding a 3D effect to sound quality, in correspondence of RPG as the identified partial genre. The current setting value of the saturation parameter may represent a setting value of the saturation parameter, set in correspondence with the representative genre of the content, and the current setting value of the brightness parameter may represent a setting value of the brightness parameter, set in correspondence with the representative genre of the content.

According to a partial genre identified as a result of frame image analysis after play of the game content has begun being RTS, the electronic apparatus 100 may control image quality according to the analyzed result. In this case, weights for controlling image quality may represent saturation of +2, sharpness of +3, and brightness of +2. That is, the electronic apparatus 100 may perform an image quality control by adding +2 to a current setting value of a saturation parameter, adding +3 to a current setting value of a sharpness parameter, and adding +2 to a current setting value of a brightness parameter, in correspondence of RTS as the identified partial genre.

According to a partial genre identified as results of frame image analysis and audio frequency analysis after play of the game content has begun being FPS, the electronic apparatus 100 may control both image quality and sound quality according to the analyzed results. In this case, a weight for controlling image quality may represent brightness of +4, and a weight for controlling sound quality may represent a 3D effect. That is, the electronic apparatus 100 may control image quality by adding +4 to a current setting value of a brightness parameter and perform a sound quality control by providing a 3D effect to sound quality, in correspondence of FPS as the identified partial genre.

According to a partial genre identified as results of frame image analysis and audio frequency analysis after play of the game content has begun being SPORTS, the electronic apparatus 100 may control both image quality and sound quality according to the analyzed results. In this case, weights for controlling image quality may represent saturation of −4 and sharpness of +3, and weights for controlling sound quality may represent a caster's voice and emphasis of shouts. That is, the electronic apparatus 100 may control image quality by adding −4 to a current setting value of a saturation parameter and adding +3 to a current setting value of a sharpness parameter, and perform a sound quality control by adding a caster's voice and emphasis of shouts to sound quality, in correspondence of SPORTS as the identified partial genre.

According to a partial genre identified as results of frame image analysis and audio frequency analysis after play of the game content has begun being Rhythm, the electronic apparatus 100 may control sound quality according to the analyzed results. In this case, a weight for controlling sound quality may represent emphasis of background music. That is, the electronic apparatus 100 may perform a sound quality control by adding emphasis of background music to sound quality, in correspondence of Rhythm as the identified partial genre.

According to a partial genre identified as results of frame image analysis and audio frequency analysis after play of the game content has begun being Fighting, the electronic apparatus 100 may control sound quality according to the analyzed results. In this case, a weight for controlling sound quality may represent emphasis of fighting sounds. That is, the electronic apparatus 100 may perform a sound quality control by adding emphasis of fighting sounds to sound quality, in correspondence of Fighting as the identified partial genre.

According to a partial genre identified as a result of audio frequency analysis after play of the game content has begun being Racing, the electronic apparatus 100 may control sound quality according to the analyzed result. In this case, weights for controlling sound quality may represent wheel friction sounds and emphasis of engine sounds. That is, the electronic apparatus 100 may perform a sound quality control by adding wheel friction sounds and emphasis of engine sounds to sound quality, in correspondence of Racing as the identified partial genre.

FIG. 10 shows an example in which weights of partial genres are determined regardless of representative genres. However, the disclosure is not limited thereto. Weights may vary depending on representative genres. For example, values that are added to a saturation parameter and a brightness parameter among image quality control parameters of RPG as a partial genre may vary depending on a representative genre.

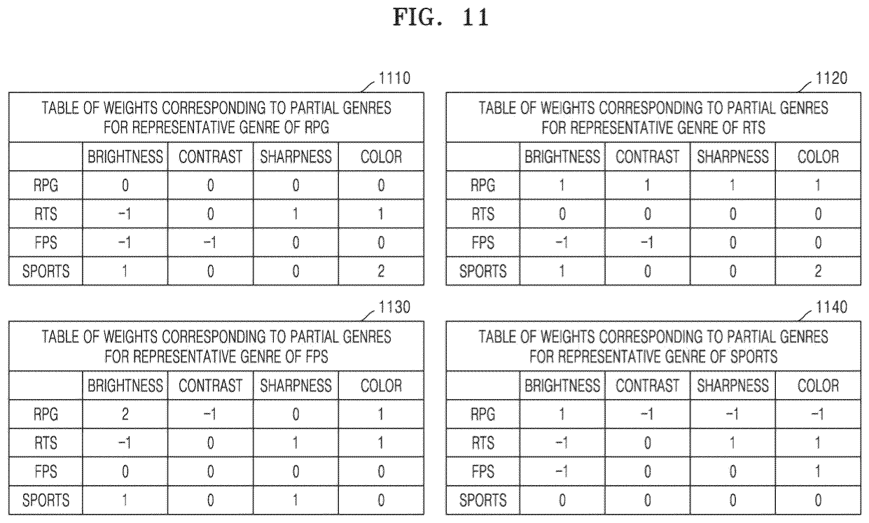

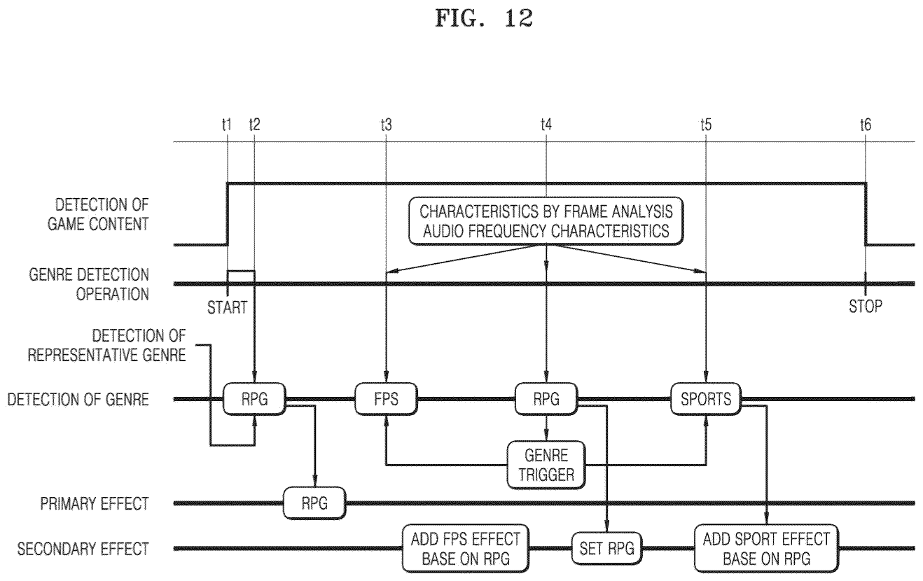

Hereinafter, an example of a method of processing image quality for each genre of game content will be described with reference to FIGS. 11 and 12. For simplification of description, only examples of processing image quality are shown.

FIG. 11 shows weight tables for representative genres of RPG, RTS, FPS, and SPORTS, according to an embodiment of the disclosure.

Referring to FIG. 11, in a weight table 1110 that lists weights corresponding to partial genres according to a representative genre of RPG, weights of a partial genre of RPG may be represented by 0 because the partial genre is identical to the representative genre. In the case in which a partial genre is RTS, a brightness parameter, a contrast parameter, a sharpness parameter, and a color parameter may represent −1, 0, 1, and 1, respectively. In the case in which a partial genre is FPS, a brightness parameter, a contrast parameter, a sharpness parameter, and a color parameter may represent −1, −1, 0, and 0, respectively. In the case in which a partial genre is SPORTS, a brightness parameter, a contrast parameter, a sharpness parameter, and a color parameter may represent 1, 0, 0, and 2, respectively.

In a weight table 1120 that lists weights corresponding to partial genres according to a representative genre of RTS, weights of a partial genre of RTS may be represented by 0 because the partial genre is identical to the representative genre. In the case in which a partial genre is RPG, a brightness parameter, a contrast parameter, a sharpness parameter, and a color parameter may represent 1, 1, 1, and 1, respectively. In the case in which a partial genre is FPS, a brightness parameter, a contrast parameter, a sharpness parameter, and a color parameter may represent −1, −1, 0, and 0, respectively. In the case in which a partial genre is SPORTS, a brightness parameter, a contrast parameter, a sharpness parameter, and a color parameter may represent 1, 0, 0, and 2, respectively.

In a weight table 1130 that lists weights corresponding to partial genres according to a representative genre of FPS, weights of a partial genre of FPS may be represented by 0 because the partial genre is identical to the representative genre. In the case in which a partial genre is RPG, a brightness parameter, a contrast parameter, a sharpness parameter, and a color parameter may represent 2, −1, 0, and 1, respectively. In the case in which a partial genre is RTS, a brightness parameter, a contrast parameter, a sharpness parameter, and a color parameter may represent −1, 0, 1, and 1, respectively. In the case in which a partial genre is SPORTS, a brightness parameter, a contrast parameter, a sharpness parameter, and a color parameter may represent 1, 0, 1, and 0, respectively.

In a weight table 1140 that lists weights corresponding to partial genres according to a representative genre of SPORTS, weights of a partial genre of SPORTS may be represented by 0 because the partial genre is identical to the representative genre. In the case in which a partial genre is RPG, a brightness parameter, a contrast parameter, a sharpness parameter, and a color parameter may represent 1, −1, −1, and −1, respectively. In the case in which a partial genre is RTS, a brightness parameter, a contrast parameter, a sharpness parameter, and a color parameter may represent −1, 0, 1, and 1, respectively. In the case in which a partial genre is SPORTS, a brightness parameter, a contrast parameter, a sharpness parameter, and a color parameter may represent 0, 0, 0, and 0, respectively.

FIG. 12 is a reference view for describing an example of image quality control based on representative genres and partial genres while game content is played, according to an embodiment of the disclosure.

Referring to FIG. 12, while the electronic apparatus 100 receives content from the content providing apparatus 200, the electronic apparatus 100 may recognize that play of game content has begun, at a time t1, based on an information signal received from the content providing apparatus 200.

According to recognition that play of the game content has begun, the electronic apparatus 100 may identify a representative genre of the game content at a time t2 to perform an appropriate image quality control for each genre of the game content. For example, the electronic apparatus 100 may identify a representative genre of the game content as RPG. Accordingly, the electronic apparatus 100 may perform an image quality control by setting image quality control parameters to setting values for image quality control parameters corresponding to the representative genre of RPG. In this way, by performing an image quality control based on a representative genre, a primary audio visual effect based on RPG characteristics may be provided to the game content.

After the electronic apparatus 100 identifies the representative genre, the electronic apparatus 100 may continue to analyze a content frame received from the content providing apparatus 200. The electronic apparatus 100 may identify a partial genre of the content by performing image frame analysis and audio frequency analysis on the content. For example, the electronic apparatus 100 may identify a partial genre of the content as FPS at a time t3. Accordingly, the electronic apparatus 100 may obtain a weight corresponding to the partial genre of FPS from an image quality control weight table corresponding to the representative genre of RPG. For example, referring to FIG. 11, the electronic apparatus 100 may obtain, as weights corresponding to the partial genre of FPS, −1, −1, 0, and 0 respectively corresponding to a brightness parameter, a contrast parameter, a sharpness parameter, and a color parameter, from the weight table 1110 that lists weights corresponding to partial genres according to the representative genre of RPG. The electronic apparatus 100 may perform an image quality control by adding the weights of −1, −1, 0, and 0 corresponding to the partial genre of FPG, respectively, to a setting value of a brightness parameter, a setting value of a contrast parameter, a setting value of a sharpness parameter, and a setting value of a color parameter, set in correspondence with the representative genre of RPG, thereby providing a secondary audio visual effect to the game content. Therefore, when a scene with prominent FPS characteristics appears while content of which a representative genre is RPG is played, weights according to the FPS characteristics may be assigned to add an effect according to the FPS characteristics based on the RPG genre, thereby providing the secondary audio visual effect.

The electronic apparatus 100 may continue to perform image frame analysis and audio frequency analysis on the content, thereby identifying a partial genre of the content. For example, the electronic apparatus 100 may identify the partial genre of the content as RPG at a time t4. Accordingly, because the partial genre of RPG is identical to the representative genre of RPG, the electronic apparatus 100 may remove the weights corresponding to FPS, assigned at the time t3, to restore the setting values of the brightness parameter, the contrast parameter, the sharpness parameter, and the color parameter, corresponding to RPG.

The electronic apparatus 100 may continue to perform image frame analysis and audio frequency analysis on the content to identify a partial genre of the content. For example, at a time t5, the electronic apparatus 100 may identify a partial genre of the content as SPORTS. Accordingly, the electronic apparatus 100 may obtain a weight corresponding to the partial genre of SPORTS from the image quality control weight table corresponding to the representative genre of RPG. For example, referring to FIG. 11, the electronic apparatus 100 may obtain, as weights corresponding to the partial genre of SPORTS, 1, 0, 0, and 2 respectively corresponding to a brightness parameter, a contrast parameter, a sharpness parameter, and a color parameter, from the weight table 1110 that lists weights corresponding to partial genres according to the representative genre of RPG. The electronic apparatus 100 may perform an image quality control by adding the weights of 1, 0, 0, and 2 corresponding to the partial genre of SPORTS, respectively, to the setting value of the brightness parameter, the setting value of the contrast parameter, the setting value of the sharpness parameter, and the setting value of the color parameter, set in correspondence with the representative genre of RPG, thereby providing a secondary audio visual effect to the game content. Therefore, when a scene with prominent SPORTS characteristics appears while content of which a representative genre is RPG is played, weights according to the SPORTS characteristics may be assigned to add an effect according to the SPORTS characteristics based on the RPG genre, thereby providing the secondary audio visual effect.

When the electronic apparatus 100 no longer receives an information signal from the content providing apparatus 200 because the play of the game content has ended, the electronic apparatus 100 may recognize an end of the game content at a time t6. According to recognition that the play of the game content has ended, the electronic apparatus 100 may no longer perform an image quality and/or sound quality control performed based on the representative genre and partial genre of the game content.

The operating method of the electronic apparatus according to an embodiment of the disclosure may be implemented in a program command form that can be executed by various computer means, and may be recorded on computer-readable media. Also, an embodiment of the disclosure may be a computer-readable recording medium according to another aspect may include a computer-readable recording medium storing at least one program including instructions for executing the operating method of the electronic apparatus.

The computer-readable recording medium may also include, alone or in combination with program commands, data files, data structures, and the like. Program commands recorded in the medium may be the kind specifically designed and constructed for the purposes of the disclosure or well-known and available to those of ordinary skill in the computer software field. Examples of the computer-readable recording medium may include magnetic media, such as hard disks, floppy disks, and magnetic tapes, optical media, such as CD-ROM and DVD, magneto-optical media such as floptical disks, and hardware devices, such as ROM, RAM, flash memory, and the like, configured to store and execute program commands. Examples of the program commands include high-level language codes that can be executed on a computer through an interpreter or the like, as well as machine language codes produced by a compiler.

The machine-readable storage medium may be provided in the form of non-transitory storage medium, wherein the term ‘non-transitory storage medium’ simply means that the storage medium is a tangible device, and does not include a signal (e.g., an electromagnetic wave), but this term does not differentiate between where data is semi-permanently stored in the storage medium and where the data is temporarily stored in the storage medium For example, the ‘non-transitory storage medium’ may include a buffer that temporarily stores data.

According to an embodiment of the disclosure, the method according to various embodiments of the disclosure may be included in a computer program product and provided. The computer program product may be traded between a seller and a purchaser as a commodity. The computer program product may be distributed in the form of a machine-readable storage medium (e.g., compact disc read only memory (CD-ROM)), or be distributed (e.g., downloadable or uploadable) online via an application store (e.g., Play Store™) or between two user devices (e.g., smart phones) directly. When distributed online, at least a part of the computer program product (e.g., a downloadable app) may be temporarily generated or at least temporarily stored in the machine-readable storage medium, such as memory of the manufacturer's server, a server of the application store, or a relay server.

What is claimed is:

1. An electronic apparatus comprising:
memory storing at least one instruction; and
at least one processor configured to execute the at least one instruction;
wherein the at least one instruction, when executed by the at least one processor, causes the electronic apparatus to:
identify a representative genre of a content, based on information about the content;
perform at least one of video image quality control or audio sound quality control on the content by setting at least one of video image quality or audio sound quality for playing the content to a preset value, based on the identified representative genre;
identify a partial genre of the content, based on analysis of a scene including at least one of a video frame or an audio frequency corresponding to at least a part of the content played; and
perform at least one of the video image quality control or the audio sound quality control on the content by assigning a weight to the preset value, based on the identified partial genre.

2. The electronic apparatus of claim 1, wherein the at least one instruction, when executed by the at least one processor, causes the electronic apparatus to:
recognize that play of the content has begun;
obtain title information of the played content by analyzing an image of the content; and
identify the representative genre of the content, based on the title information of the content.

3. The electronic apparatus of claim 1, wherein the content includes game content, and
wherein the at least one instruction, when executed by the at least one processor, causes the electronic apparatus to:
recognize that play of the content has begun, based on at least one signal among Variable Refresh Rate (VRR), Auto Low Latency Mode (ALLM), or ContentsType, received from an external apparatus connected to the electronic apparatus to provide the content.

4. The electronic apparatus of claim 1, wherein the at least one instruction, when executed by the at least one processor, causes the electronic apparatus to:
identify, as the representative genre of the content, a genre selected from among a plurality of preset genres, based on the information about the content.

5. The electronic apparatus of claim 1, wherein the at least one instruction, when executed by the at least one processor, causes the electronic apparatus to:
identify, as the partial genre of the content, a genre selected from a plurality of preset genres, based on the analysis of the scene.

6. The electronic apparatus of claim 1, wherein the at least one instruction, when executed by the at least one processor, causes the electronic apparatus to:
obtain at least one of a setting value of at least one parameter for controlling the video image quality, or a setting value of at least one parameter for controlling the audio sound quality, corresponding to the representative genre; and
control at least one of the video image quality or the audio sound quality, by setting the at least one parameter for controlling the video image quality by using the setting value of the at least one parameter for controlling the video image quality or by setting the at least one parameter for controlling the audio sound quality by using the setting value of the at least one parameter for controlling the audio sound quality.

7. The electronic apparatus of claim 1, wherein the at least one instruction, when executed by the at least one processor, causes the electronic apparatus to:
perform at least one of the video image quality control or the audio sound quality control on the content, by adjusting at least one of a setting value of at least one parameter for setting the video image quality or a setting value of at least one parameter for setting the audio sound quality, corresponding to the representative genre, by using the weight corresponding to the identified partial genre.

8. The electronic apparatus of claim 1, wherein the at least one instruction, when executed by the at least one processor, causes the electronic apparatus to:
identify whether the identified partial genre is identical to the representative genre;
perform, based on the identified partial genre being identical to the representative genre, at least one of the video image quality control or the audio sound quality control by using at least one of a setting value of at least one parameter for controlling the video image quality or a setting value of at least one parameter for controlling the audio sound quality, corresponding to the representative genre; and
adjust, based on the identified partial genre being different from the representative genre, at least one of the setting value of the at least one parameter for controlling the video image quality or the setting value of the at least one parameter for controlling the audio sound quality, corresponding to the representative genre, by using the weight corresponding to the identified partial genre.

9. The electronic apparatus of claim 1, wherein the at least one instruction, when executed by the at least one processor, causes the electronic apparatus to:
obtain a table storing the weight that is added to a setting value of at least one parameter for controlling the video image quality, corresponding to the representative genre, in correspondence with each of a plurality of preset genres,
wherein the weight varies in a range of preset values.

10. An operating method of an electronic apparatus, the operating method comprising:
identifying a representative genre of a content, based on information about the content;
performing at least one of video image quality control or audio sound quality control on the content by setting at least one of video image quality or audio sound quality for playing the content to a preset value, based on the identified representative genre;
identifying a partial genre of the content, based on analysis of a scene including at least one of video frame or an audio frequency corresponding to at least a part of the content played; and
performing at least one of the video image quality control or the audio sound quality control on the content by assigning a weight to the preset value, based on the identified partial genre.

11. The operating method of claim 10, further comprising:
recognizing that play of the content has begun;
obtaining title information of the played content by analyzing an image of the content; and
identifying the representative genre of the content, based on the title information of the content.

12. The operating method of claim 10, wherein the content includes game content, and
wherein the operating method further comprises:
recognizing that play of the content has begun, based on at least one signal among Variable Refresh Rate (VRR), Auto Low Latency Mode (ALLM), or ContentsType, received from an external apparatus connected to the electronic apparatus to provide the content.

13. The operating method of claim 10, further comprising:
identifying a genre selected from among a plurality of preset genres as the representative genre of the content, based on the information about the content.

14. The operating method of claim 10, further comprising,
identifying, as the partial genre of the content, a genre selected from a plurality of preset genres, based on the analysis of the scene.

15. The operating method of claim 10, further comprising:
obtaining at least one of a setting value of at least one parameter for controlling the video image quality or a setting value of at least one parameter for controlling the audio sound quality, corresponding to the representative genre; and
controlling at least one of the video image quality or the audio sound quality, by setting the at least one parameter for controlling the video image quality by using the setting value of the at least one parameter for controlling the video image quality or by setting the at least one parameter for controlling the audio sound quality by using the setting value of the at least one parameter for controlling the audio sound quality.

16. The operating method of claim 10, further comprising:
performing at least one of the video image quality control or the audio sound quality control on the content, by adjusting at least one of a setting value of at least one parameter for setting the video image quality or a setting value of at least one parameter for setting the audio sound quality, corresponding to the representative genre, by using the weight corresponding to the identified partial genre.

17. The operating method of claim 10, further comprising:
identifying whether the identified partial genre is identical to the representative genre;
performing, based on the identified partial genre being identical to the representative genre, at least one of the video image quality control or the audio sound quality control by using at least one of a setting value of at least one parameter for controlling the video image quality or a setting value of at least one parameter for controlling the audio sound quality, corresponding to the representative genre; and
adjusting, based on the identified partial genre being different from the representative genre, at least one of the setting value of the at least one parameter for controlling the video image quality or the setting value of the at least one parameter for controlling the audio sound quality, corresponding to the representative genre, by using the weight corresponding to the identified partial genre.

18. The operating method of claim 10, further comprising:
obtaining a table storing the weight that is added to a setting value of at least one parameter for controlling the video image quality, corresponding to the representative genre, in correspondence with each of a plurality of preset genres,
wherein the weight varies in a range of preset values.

19. A non-transitory computer-readable recording medium storing at least one instruction to cause, when the at least one instruction is executed by at least one processor of an electronic apparatus, the electronic apparatus to:
identify a representative genre of a content, based on information about the content;
perform at least one of video image quality control or audio sound quality control on the content by setting at least one of video image quality or audio sound quality for playing the content to a preset value, based on the identified representative genre;
identify a partial genre of the content, based on analysis of a scene including at least one of video frame or an audio frequency corresponding to at least a part of the content played; and
perform at least one of the video image quality control or the audio sound quality control on the content by assigning a weight to the preset value, based on the identified partial genre.

20. The non-transitory computer-readable recording medium of claim 19, wherein the at least one instruction is executed by the at least one processor to cause the electronic apparatus to:
recognize that play of the content has begun;
obtain title information of the played content by analyzing an image of the content; and
identify the representative genre of the content, based on the title information of the content.
